(19) United States
(12) Patent Application Publication
(10) Pub. No.: US 2021/0350017 A1
(43) Pub. Date: Nov. 11, 2021

(54) ENCRYPTION SYSTEM

(71) Applicant: Secure Design Limited, Borehamwood, Herts (GB)

(72) Inventors: Raymond Paul GORDON, Radlett, Hertfordshire (GB); Andrew John FISHER, Cambridge, Cambridgeshire (GB)

(21) Appl. No.: 17/261,099

(22) PCT Filed: Jul. 16, 2019
(86) PCT No.: PCT/IB2019/056070

§ 371 Date: Jan. 18, 2021

(30) Foreign Application Priority Data
Jul. 19, 2018 (GB) 1811807.5

(51) Int. Cl. G06F 21/62; G06F 21/60; G06F 21/85

(52) U.S. Cl. CPC G06F 21/6227; G06F 21/602; G06F 2221/0751; G06F 21/85; G06F 21/604

(57) ABSTRACT

There is disclosed a processing device, comprising a mass storage interface for connecting to a host device; at least one processor; and computer program code executable by the at least one processor, wherein the computer program code, when executed by the at least one processor, causes the processing device: to receive at least one file from the host device via the mass storage interface; to receive a disconnection request via the mass storage interface; and in response to the disconnection request, to perform a processing task on each file. The processing device may be an encryption device, and the processing task may comprise performing an encryption or decryption operation on the at least one file.

### CROSS-REFERENCED TO RELATED APPLICATIONS

This application claims priority from and is related to the following prior application entitled “ENCRYPTION SYSTEM,” PCT Patent Application No. PCT/IB2019/056070, filed Jul. 16, 2019, which claims priority from and is related to the following prior application entitled “ENCRYPTION SYSTEM,” Great British Patent Application No. GB 1811807.5, filed Jul. 19, 2018. Each of these prior patent applications, including the entirety of the written description and drawing figures, are hereby incorporated into the present application by reference.

### FIELD OF THE INVENTION

The present invention relates to a processing device, an encryption device and a method of carrying out a session-based task in a device presenting a mass storage interface. The invention finds particular application in the field of cryptography.

### BACKGROUND OF THE INVENTION

Guarding private electronic data is increasingly important. Normally one seeks to secure data whether it is stored locally or in ‘the cloud’. Data should also be protected against interception during transmission to others.

There are numerous solutions on the market that secure data through encryption. Software solutions tend to be complex or suffer from security defects. Passwords that protect encrypted vaults or transfer services may be captured by key loggers. Vaults are also susceptible to malware attacks. On-line (cloud) services are both simple and convenient, but require an element of trust from the user. How well is data really encrypted and protected? Is there a backdoor built into the service which enable snooping by privileged parties?

Hardware solutions, which generally take the form of an encrypted external storage device, are more secure. They normally require authentication on the device itself via a PIN, fingerprint sensor or ID card. However, everything is stored on the portable device, which is a problem if it is mislaid or fails. Also, there is no easy way to send individual encrypted files without sending the entire device to someone else.

There is a need for a simpler encryption device that facilitates easy transmission of encrypted files, and which is much less vulnerable to attack than the other solutions. There is also a need for alternative and more effective implementations for interfacing with external hardware.

The present invention aims to solve the problems mentioned above, and to address the identified needs.

### SUMMARY OF THE INVENTION

According to a first aspect of the present invention, there is provided a processing device, comprising: a mass storage interface for connecting to a host device; at least one processor; and computer program code executable by said at least one processor, wherein the computer program code, when executed by said at least one processor, causes the processing device: to receive at least one file from the host device via the mass storage interface; optionally to receive a disconnection request via the mass storage interface; and optionally in response to the disconnection request, to perform a processing task on each file (the processing task preferably being unrelated to standard mass storage functions). Preferably the device is caused to disconnect from the host device in response to the disconnection request, and caused (by itself) to reconnect to the host device on completion of the processing task. Preferably the processing task is session-based. The term ‘session-based’ preferably connotes a processing task carried out over a finite time (predetermined or otherwise), which may for example rely on there being no changes made to the files during that time.

Disconnection requests issued to mass storage devices have a clear purpose within the art of instructing the mass storage device to prepare for physical removal (so to ensure all caches are cleared and that hard disk heads are parked, and so on). Disconnection requests are usually manually issued by users for the simple reason that a host device is not able to predict when a user will decide to unplug a device. The present invention stems from the inventive realisation, contrary to the existing technical prejudices, that the disconnection request could be used for a different purpose. By firstly attaching an external processing device to a host device via the mass storage interface (and preferably using the mass storage protocol), despite the external processing device not being a mass storage device, and then secondly, using the mass storage disconnection request to trigger processing of files copied to the processing device, a simple session-based processing device can be implemented without the need for any custom interface or operating commands. Furthermore, advantage can be taken of the highly polished ‘drag and drop’ environments built in to operating systems for use with external mass storage devices, without needing to replicate any functionality.

The present invention also overcomes the difficulty whereby mass storage devices typically receive sector-level data rather than file-level data, and are not typically notified (and cannot normally determine) when the transmission of individual files commences and ends; thus the skilled person would not normally expect to be able to carry out file-based processing using a mass storage interface. The present invention stems in part from the inventive realisation that this is possible at all.

The processing device, in more detail, will preferably disconnect from the host device on receipt of the disconnection request, and preferably processes each file in dependence on a property of the file, including but not limited to the file location, the file name and the file contents. Preferably each file will be stored and/or transformed in some fashion, but need not be. The files may for example be output by the processing device in any appropriate fashion, as described below, and preferably the processing device reconnects to the host device on completion of the task(s). In some embodiments the interface need not be a mass storage interface. Preferably after receiving the disconnection request, the device internally mounts the simulated mass storage device so as to determine the file structure.

The processing device is preferably further caused: to present at least one virtual folder to the host device via the mass storage interface; to receive an association between each file and a respective virtual folder; and to perform a processing task on each file in dependence on its respective folder.

Preferably the association between the file and the virtual folder is provided as the desired file path specified when the file is transferred to the processing device by the host device. The term ‘virtual folder’ preferably connotes a folder which does not correspond to a physical entity, such as a location within persistent storage and/or within a mass storage device. Preferably the processing device stores said at least one file in non-persistent memory. In one particularly advantageous embodiment, the processing task comprises performing an encryption or decryption operation on said at least one file.

Accordingly, in a further aspect of the invention, there is provided an encryption device comprising: an interface for connecting to a host device; at least one processor; and computer program code executable by said at least one processor, wherein the computer program code, when executed by said at least one processor, causes the encryption device: to receive at least one file for processing from the host device via the interface; to receive a disconnection request; and optionally in response to the disconnection request: to perform an encryption or decryption operation on said at least one file. Preferably the encryption device is caused to disconnect from the host device also in response to the disconnection request (though this may not be necessary).

In addition to the general benefits mentioned above in relation to a processing device, the application of these features to an encryption device provide a synergy in that the disconnection request which allows the processing to be instructed without requiring a dedicated interface, protocol, or software on the host device, also allows the encryption and decryption to be carried out in a more secure fashion, since there is no flow of data taking place between the host device and encryption device while they are disconnected. Thus, the encryption device is able to perform the most sensitive cryptographic operations without significant fear of electronic intrusion from the host device.

The term ‘encryption device’ preferably connotes a device using encryption-related algorithms which may perform either or both of encryption and decryption of data (it may for example be a decryption-only device or an encryption-only device). The disconnection request may specifically be a dismount, eject or disconnect command, or the like. Preferably it is a command or other communication indicating at least one of: that the device can be removed from the host; that it is desired that the device be removed from the host; and that it is intended for communications between host and device to cease or to be reduced. Preferably the disconnection request is not normally associated with carrying out any processing task and/or carrying out session-related behaviour. Preferably the disconnection request is not normally followed by a reconnection by the same device to the same host (or at least within a relevant time frame such as a number of seconds, a number of minutes, or a number of hours). The disconnection request may be issued via the interface or by other means, and may be an electronic signal or may be a physical interaction, for example directly with the device via a button or other appropriate physical or other input means. In the case that the disconnection request is received directly via the device (or otherwise), the device may be further caused to send a disconnection request to the host, for example (but not necessarily) via the interface.

The encryption device may include an LED or other visual (or other form of) output for indicating the status of the device, including but not limited to statuses including: connected to host; disconnected from host; processing; processing complete; paired with other device; not yet paired with other device; safe to remove; unsafe to remove; storage full; and so on. The device may include a speaker and emit a sound or provide any other appropriate output to indicate any of these statuses, for example.

Preferably the interface is a mass storage interface, and said at least one file is received using a mass storage protocol associated with the mass storage interface, providing some of the advantages mentioned above in relation to the processing device.

The encryption device may further comprise a file storage module (comprising one or more memory and/or storage units), and wherein the device is further caused, on receiving said at least one file, to store said at least one file in the file storage module, and wherein performing the encryption or decryption operation comprises replacing each file in the data storage with a processed version. Preferably the processed version of each file is stored in a separate location to the original file, but need not be.

Preferably the encryption device is caused to create a file system structure in the file storage module, preferably either prior to connecting to the host device or in response to connecting to (or receiving a connection request from) the host device. Preferably the encryption device is also caused to format the file storage module before creating the file system structure.

Preferably the encryption device is further caused: to add filing system level encryption to each file, optionally using a first encryption standard, as (or when) it is stored in the file storage module using a filing system encryption key; to remove the filing system level encryption from each file, optionally using the first encryption standard, as it is read out of the file storage module using the filing system encryption key. Optionally performing the (main) encryption or decryption operation (for files which are destined for a less secure environment) comprises using a second encryption standard (algorithm and/or key size) to encrypt or decrypt each file. The second encryption standard may be stronger than the first, at least in terms of at least one of a plurality of metrics such as key size, algorithm type, and so on, but for simplicity it is preferably the same. Either encryption standard is preferably relatively quick to apply and is preferably a symmetric key algorithm such as AES, triple-DES or plain DES, and is preferably efficient enough to be used transparently or on-the-fly while saving the file(s). The second encryption standard in some cases may be a public/private key algorithm such as RSA and PGP. Accordingly, at no point is data stored on the device in an unencrypted form.

Typically, in accordance with mass storage protocols, each file is received as one or more separate portions (such as sectors of the simulated mass storage device), and the filing system level encryption is applied to each portion (or sector, or other fixed-size or variable-size chunk, and so on) as it is stored.

Preferably the filing system encryption key is stored in non-persistent memory and is deleted in response to the encryption device being removed from the host. Alternatively, or additionally, the encryption device is preferably configured such that files stored in the file storage module are stored in non-persistent memory (also) and are deleted in response to the encryption device being removed from the host.

In one embodiment, the encryption device (employing an appropriate power source) is caused to manually erase the files and/or the filing system encryption key on detection of a relevant event indicating that the session is likely ended. That event may include at least one of: the physical removal of the device; the host powering off; a log off or shut down event in the host; an unauthorised attempt to access the device; unusual communications activity; a time-out since the last communication from the host; a time-out since the start of the encryption session; physical tampering with the device; and electronic tampering with the device. Preferably the deletion of the filing system encryption key and/or the files happens automatically, however. The non-persistent memory may be volatile memory, such as RAM, which loses its contents when it loses power, or any other type of storage device in which the contents are erased after a predetermined length of time or after a predetermined event, and so on.

In a preferred embodiment, the non-persistent data storage is powered by the host device via the mass storage interface, and removing power from the non-persistent data storage causes the contents of the data storage to be erased, whereby removing the encryption device from the host device automatically prevents decryption of files stored in the file storage module (either by erasing the files or the encryption key needed to access them, or both). This increases the cryptographic security of the device.

Preferably the encryption device is further caused: to present at least one virtual folder to the host device via the mass storage interface; to receive an association between each file and a respective virtual folder; and to perform a processing task on each file in dependence on its respective virtual folder. One or more processing tasks may be associated in any manner with the folders in a one-to-one, one to many, many to one, or many to many relationship. Preferably the virtual folders are created each time the encryption device is connected to the host device, and preferably do not correspond to a real folder structure stored within the encryption device.

The encryption device may be configured to receive at least one further file via the mass storage interface, wherein the encryption device is further caused to identify said at least one further file as a configuration file, and wherein the encryption device is further caused to carry out at least one configuration operation in dependence on the said at least one further file.

Alternatively, or additionally, the encryption device may be configured to receive a command to modify a virtual file or folder, wherein the encryption device is further caused to carry out at least one configuration operation in dependence on said modification.

In either or both of these cases, the configuration operation may comprise at least one of: storing configuration data, modifying configuration data, modifying access rights, creating access rights, creating authentication data and modifying authentication data.

The data storage may comprises at least one ‘inbox’ storage area and at least one ‘outbox’ storage area, and wherein the encryption device is further caused: to store the received said at least one file in the inbox storage area; and to store said at least one processed version of said at least one file in the outbox storage area once encrypted or decrypted, whereby files are in effect moved from the inbox storage area to the outbox storage area once they have been processed. The names ‘inbox’ and ‘outbox’ preferably connote pre-processing and post-processing, and are not intended to have any further significance. The storage areas may be named and may as an example include the names ‘inbox’ and ‘outbox’ but need not be so limited. The user (or other entity) may rename the folders as appropriate. The storage areas are preferably presented to the host as folders within a file system. More preferably, the user of the host device is able to ‘drag and drop’ files to and from the folders as with any conventional mass storage device. It may be desired to make items in the inbox storage area write-only (but optionally deletable) and items in the outbox storage area read-only.

Preferably the encryption device is further caused to present the file storage module to the host as a mass storage file system and preferably the file extension of each file is changed after encryption to a file extension indicating that the file is encrypted. Conversely, preferably the file extension of each file is changed after decryption to reflect the original file type.

Preferably the device is further caused (where possible and/or appropriate) to reconnect to the host after performing the encryption or decryption operation. Reconnecting is preferably initiated by the device, creating a more seamless and efficient user experience, but could be initiated by the host. Reconnection also indicates the end of the encryption session, and prevents any data transfers during the session. Typical mass storage protocols (such as USB mass storage protocols) may not permit session-based access or to allow access to be controlled in any similar way. The user is also given a prompt that the device is ready to be used again (the reconnection notice) without having to provide any custom software or custom interface with the operating system. The reconnection is preferably initiated (directly) in response to completion of processing, whereby the disconnection and reconnection define a session.

The encryption device may be further caused to disconnect electronically from the host device while remaining in physical contact. Disconnecting electronically may comprise entering a state where at least some communications from the host are ignored. For added security, the interface may include at least one electrical signal connection and disconnecting electronically may comprise disconnecting at least one said electrical signal connection. Such disconnection may be physical, for example through operation of a MEMS switch, electrical relay or similar, or may be electronic, for example through the operation of a transistor or similar.

Preferably the interface is a USB interface and reconnecting to the USB host comprises sending a USB connection request to the host device. Also preferably the interface is a USB interface and the disconnection request is a USB eject request. The interface may alternatively be an MMC/SD interface, and the encryption device may be encapsulated in an SD/MMC style memory card. Other package sizes, shapes and protocols are of course possible.

The device may be further caused to receive authentication data, and wherein the encryption device is further caused to validate the authentication data before performing an encryption or decryption operation on said at least one file (in particular, the operation may not be permitted if the authentication fails). A password may be needed to access the decryption facility, for example, or otherwise to access the device.

In particular, the authentication data may be at least one of: password; pass key; PIN; public key; cryptographic signature; text or other data within at least one file or folder; a name given to a file or folder during a renaming operation; and the deletion, addition or alteration of a file or folder in a location within a file system that is indicative of a pass phrase or code.

The authentication data may be communicated by the deletion, addition or alteration of a file or folder, said file or folder being located within at least one subfolders, each subfolder corresponding to a portion of the pass phrase or code, and the pass phrase or code being formed by combining the portions of the pass phrase or code relating to each subfolder. For example, a PIN of 3935 may be communicated by manipulating a file within successive subfolders having names of ‘3’, ‘9’, ‘3’ and ‘5’. Words, phrases or other characters may alternatively be indicated by the subfolder names. The authentication method may in some cases involve a combination of any of the above-mentioned methods.

These authentication methods may be provided independently. For example there may be a processing (or other) device providing access to a file system (by any appropriate means) and including an authentication module for providing authentication using a method as aforesaid.

The encryption device may be attachable to a further said encryption device, and wherein the encryption device is further caused to communicate with the further encryption device to facilitate the exchange of cryptographic data. The encryption device may comprise a further interface, being attachable to the further encryption device via the further interface. Alternatively, the encryption device may be attachable to the further encryption device by the same interface used to connect to the host device (for example using a suitable intermediary device, power supply and/or male-to-female conversion). Power is preferably passed on through the further interface to the further device. Accordingly, the failsafe data deletion will occur in both devices if the first device is unplugged. Preferably the further interface is of the same type as the first interface, and the encryption device is attachable to the second encryption device via either the first interface or the second interface. Accordingly, the first and further interface may comprise a matching male and female interface. Preferably the communication between the encryption device and further encryption device is initially via a mass storage protocol, and more preferably a signal is sent via the mass storage protocol to initiate a transition to a further protocol, for example a bi-directional data protocol such as CDC. Preferably the signal is sent from the encryption device to the further encryption device, and preferably the signal constitutes an invalid mass storage protocol request, wherein preferably the nature of the error and/or an associated at least one parameter indicate at least one of the identity or type of the encryption device, the protocol to transition to, and cryptographic-related or other data.

The encryption device is preferably further caused to pair with the further encryption device. ‘Pairing’ preferably connotes establishing some form of relationship between the devices, preferably a cryptographic relationship, which relationship preferably persists after the devices are disconnected from one another. Pairing can occur whether the encryption device is connected to the host device or otherwise (but may in some cases require power to be supplied by such a connection), for either because none of the encryption devices is connected to a host device, or because the further encryption device is connected to a host device and the first encrypted device is connected to the second interface of the further encrypted device. Preferably pairing occurs only once, but the pairing can be refreshed or forgotten as appropriate, for example at the direction of a user of either the encrypted device or the further encrypted device.

In pairing, the encryption device is preferably further caused to exchange cryptographic keys with the further encryption device, such that at least one said encryption device is able to decrypt files encrypted by the other said encryption device. This may comprise communicating with the further device using an encrypted protocol. In the case where virtual folders are provided, the said at least one virtual folder may include at least one virtual folder (or file) representing the pairing between the encryption devices.

The encryption device may be further caused to receive a pairing request from a remote encryption device to which it is not physically connected, and to pair with the remote encryption device by exchanging messages with the remote encryption device. This request is preferably received via the interface but could be received by other means, for example using appropriate wireless communication hardware and protocols. The remote device is preferably a further said device but need not be. Preferably the pairing request and any subsequent exchange of data with the remote device is encrypted appropriately, for example using appropriate public keys and private keys held within each device and/or derived from other secret keys. Thus a workable system can be provided for remote pairing, but the system is less cryptographically secure than one involving only physical pairing. However, the encryption device may be further caused to create a new pairing with the remote device on detection of the remote device being attached to the encryption device via a second interface. This can restore the cryptographic security once the devices are brought to the same location.

In one usage case, the encryption device is caused to be paired in a one-to-many fashion with a plurality of other devices, whereby the encryption device is designated as an originator device and the plurality of other devices are designated as group devices. Preferably the plurality of other devices are the same type as the encryption device, and the pairing is preferably automated. Preferably the pairing is configured such that each group device can decrypt files which have been encrypted by the originator device. Typically the reverse is not true, and the communication is one-way. Optionally the originator cannot decrypt the file once encrypted, requiring a paired device to decrypt thereafter.

In another usage case, the encryption device is caused to be paired in a many-to-many fashion with a plurality of other devices, whereby all of the devices are designated as group devices. In this case, a predetermined set of devices selected from the group devices may be designated as originators, and may be capable of encrypting files that can be decrypted by all of the group devices. Preferably each of the group devices can decrypt files encrypted by any other group device. Other arrangements, for example including a different arrangement of group and originator devices, are of course possible

In another aspect, which may be provided in independent form, the encryption device is further caused to: detect connection of a reprogramming module; to receive configuration data from the reprogramming module, and to store the configuration data, wherein preferably the configuration data includes cryptographic data that is used to perform the encryption or decryption operation. Preferably the reprogramming module is connected via the interface using custom encrypted protocol, with no data exposed externally. The cryptographic data preferably comprises security credentials for use by the encryption device so as to provide a cryptographic clone of a different said encryption device.

The reprogramming module can be used for recovery purposes but is not so limited. It can for example be used to provide an initial configuration for a factory issue encryption device. The recovery module is preferably provided with an identifier to assist in recovery operations (or otherwise). In one embodiment, at least one cryptographic key associated with the encryption device is stored in a central repository, and can be transmitted to a recovery module or to the encryption device on demand, for example after providing appropriate authentication. In a more preferred embodiment, at least one cryptographic key in the encrypted device is secret within the encryption device. At least one cryptographic key may be generated within the encryption device, for example using random or pseudo-random number generators, and thus may never exist outside the encryption device at any time, leading to increased security. In addition, the user typically never knows or needs to know any of the cryptographic keys within the encryption device, and thus does not present a security risk as regards the knowledge of the cryptographic key(s) in the encryption device.

The use of the recovery module can reset an existing device if the cryptographic data is corrupted, or can program a new or different encryption device to behave as a clone of a different encryption device (for example one which no longer works). No software is required but helper software on the device host (or elsewhere) can assist.

The encryption device may be further caused to generate a backup data file for export, said backup data file including configuration data from the encryption device, and to encrypt the backup data file. The backup data file may be copied from the encryption device, for example to the host device, so that it can be backed up as required. Preferably the encryption device is further caused to receive a backup data file from the host device, and to process the backup data file on request so as to restore configuration data in the encryption device. The encryption device may be provided in the form of a USB key drive. The encryption device could be provided internally or otherwise attached more permanently to a host device.

The encryption device or processing device may be caused to receive a message from a (non-operating system) software component of the host device (such as a ‘helper app’), and preferably to communicate with the software component, for example to provide an alternative or additional means of coordinating file transfer with the host device and/or receiving and processing configuration data. The software component may in turn be in communication with other software components, for example resident in a phone or other device associated with a user of the host device and/or encryption device.

The present invention also provides a method of carrying out a session-based task in a device presenting a mass storage interface, the method comprising: connecting to a host device via the mass storage interface; receiving a disconnection request from the host device via the mass storage interface; and in response to the disconnection request: disconnecting from the host device; and carrying out the session-based task. The method in particular preferably further comprises receiving data via the interface and optionally storing the data (for example in a mass storage module), wherein the session-based task operates on the received data. The method may further comprise sending a reconnection request to the host after carrying out the session-based task. The session-based task may produce result data, and the method may further comprise reconnecting with the host and transferring the result data to the host. There may in a related aspect be provided a device including a processor and associated memory including computer program code, a mass storage module, and an interface for providing access to the mass storage module, and wherein the computer program code when executed by the processor causes the device to carry out the method as aforesaid.

In a further aspect of the invention there is provided a processing device having a mass storage interface connectable to a host device, the mass storage interface being usable in connection with a mass storage protocol, and the processing device being configured to receive at least one file from the host device using the mass storage protocol, and to transmit said at least one file back to the host device using the mass storage protocol, wherein said at least one file is returned to the host device in a transformed state. Preferably the processing device processes said at least one file, preferably to enhance it, more preferably to encrypt or decrypt the files, and wherein the mass storage protocol is preferably the USB mass storage protocol. Other features may be provided as aforesaid unless technically impossible.

In another aspect of the invention there is provided a non-transitory computer readable medium tangibly embodying computer program code which, when executed by one or more computer processors, causes the computer to carry out a method as aforesaid.

Although the embodiments of the invention described herein with reference to the drawings may comprise computer-related methods or apparatus, the invention may also extend to program instructions, particularly program instructions on or in a carrier, adapted for carrying out the processes of the invention or for causing a computer to perform as the computer apparatus of the invention. Programs may be in the form of source code, object code, a code intermediate source, such as in partially compiled form, or any other form suitable for use in the implementation of the processes according to the invention. The carrier may be any entity or device capable of carrying the program instructions. The computer program code as aforesaid may be provided in any other appropriate and tangible form (such as a computer readable signal or encoded onto any general purpose or other computing device or hardware). The computer readable medium may, for example, be a CD, DVD, Blu-ray® disc, or similar, or a hard disk, solid state disk, integrated circuit, and so on.

Although various aspects and embodiments of the present invention have been described separately above, any of the aspects and features of the present invention can be used in conjunction with any other aspect, embodiment or feature where appropriate. For example apparatus features may where appropriate be interchanged with method features. References to single entities should, where appropriate, be considered generally applicable to multiple entities and vice versa. Unless otherwise stated herein, no feature described herein should be considered to be incompatible with any other, unless such a combination is clearly and inherently incompatible. Accordingly, it should generally be envisaged that each and every separate feature disclosed in the introduction, description and drawings is combinable in any appropriate way with any other unless (as noted above) explicitly or clearly incompatible.

### BRIEF DESCRIPTION OF THE DRAWINGS

The invention will now be described further, by way of example, with reference to the accompanying drawings, in which:

FIG. 1 is a schematic of a first embodiment of an encryption system, including an encryption device;

FIG. 2 is a schematic of the encryption device of FIG. 1;

FIG. 3 is a schematic of the persistent memory module of the encryption device of FIG. 1;

FIG. 4 is a schematic of the non-persistent memory module of the encryption device of FIG. 1;

FIG. 5 is a schematic of the file storage module of the encryption device of FIG. 1;

FIG. 6 is a more detailed schematic of the encryption device of FIG. 1, showing typical data flows within the device;

FIG. 7 is another schematic of the encryption system of FIG. 1, illustrating signal and power connections;

FIG. 8 is another schematic of the encryption system of FIG. 1 illustrating signal flows;

FIG. 9 is a schematic of an embodiment of a processing device similar to the encryption device of FIG. 1;

FIG. 10 is a flow chart of the process of securely processing a file using the device of FIG. 1 or FIG. 9;

FIGS. 11a to 11c are flow charts of the process of securely encrypting or decrypting a file using the device of FIG. 1;

FIG. 12 is a schematic showing a reprogramming module attached to the device of FIG. 1 or FIG. 9;

FIG. 13 is a flow chart of the process of reprogramming the device of FIG. 1 or FIG. 9 with the reprogramming module of FIG. 12;

FIG. 14 is an illustration of the device of FIG. 1;

FIG. 15 is an illustration of the reprogramming module of FIG. 12;

FIG. 16 is an illustration of an alternative connection arrangement of the encryption device and reprogramming module;

FIG. 17 is an illustration of a further alternative connection arrangement of the encryption device and reprogramming module;

FIG. 18 is a further illustration of two devices of FIG. 1 and the reprogramming module of FIG. 12;

FIGS. 19a to 19e are screen shots illustrating the operation of the device of FIG. 1;

FIG. 20 is a schematic of a network of interconnected host devices and associated encryption devices;

FIG. 21 is a schematic of a persistent memory module of a variant of the encryption device of FIG. 1;

FIG. 22 is a schematic of a non-persistent memory module of a variant of the encryption device of FIG. 1;

FIG. 23 is a schematic of a variant of the encryption system of FIG. 1, illustrating signal and power connections;

FIG. 24 is an alternative illustration of the filing system used by the device of FIGS. 1 and 9;

FIG. 25 is a schematic showing the pairing of two encryption devices;

FIG. 26 is a flow chart illustrating the process of connecting to another device via a communication interface so as to initiate a pairing between the devices;

FIGS. 27A to 27D are flowcharts illustrating the process of processing a password file modified by a user.

FIG. 28 is a flowchart illustrating an alternative method of unlocking a device with a password; and

FIG. 29 is a flowchart illustrating a method of unlocking a device with a numeric PIN.

### DETAILED DESCRIPTION OF THE PREFERRED EMBODIMENT(S)

Various embodiments of an encryption/decryption device and a general processing device will now be described.

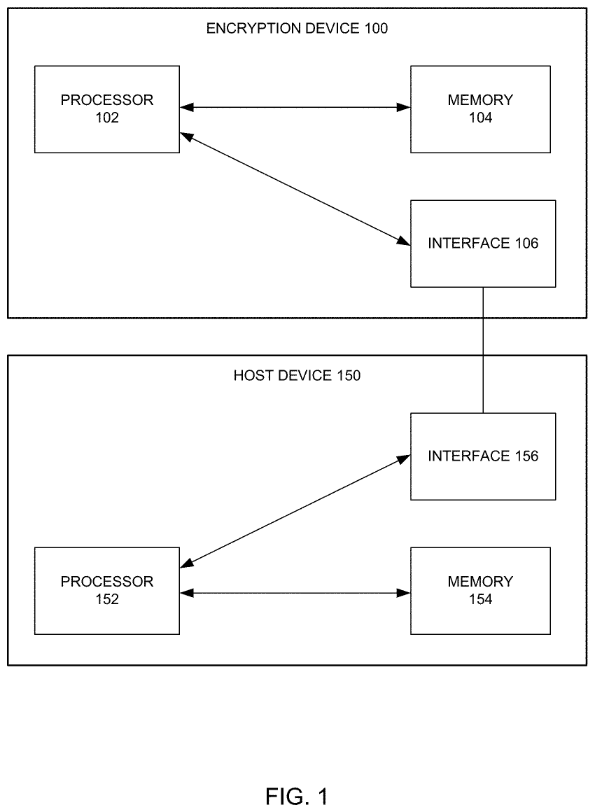

FIG. 1 is a schematic of a first embodiment of an encryption system, including an encryption device. The encryption device 100 includes one or more processors 102, one or more associated memory modules 104, and an interface 106 for connecting to a host device 150. The host device 150 includes a processor 152, memory 154 and a matching interface 156. In a preferred embodiment, the interfaces 106, 156 are mass storage interfaces, and in particular USB mass storage interfaces with physical and electrical properties defined by the relevant USB standard(s). Other options are possible, including software and/or hardware standards such as IDE, SCSI, ATAPI, MultiMediaCard, and so on.

The main requirement for the interface 106 is a bidirectional file transfer capability and (in preferred embodiments) the ability to receive a disconnection request from the device host and (more preferably) the ability to send a reconnection request to the device host and (yet more preferably) the ability to supply power to the device. Any physical or software interface may be appropriate if it can fulfil those requirements. The standard USB mass storage interface normally meets these requirements. The encryption device 100 may include an additional power supply interface or internal or external power supply (such as a rechargeable or disposable battery of appropriate size), for example where the interface 106/156 is not able or not configured to provide a power supply to the encryption device (or it is chosen not to rely on it).

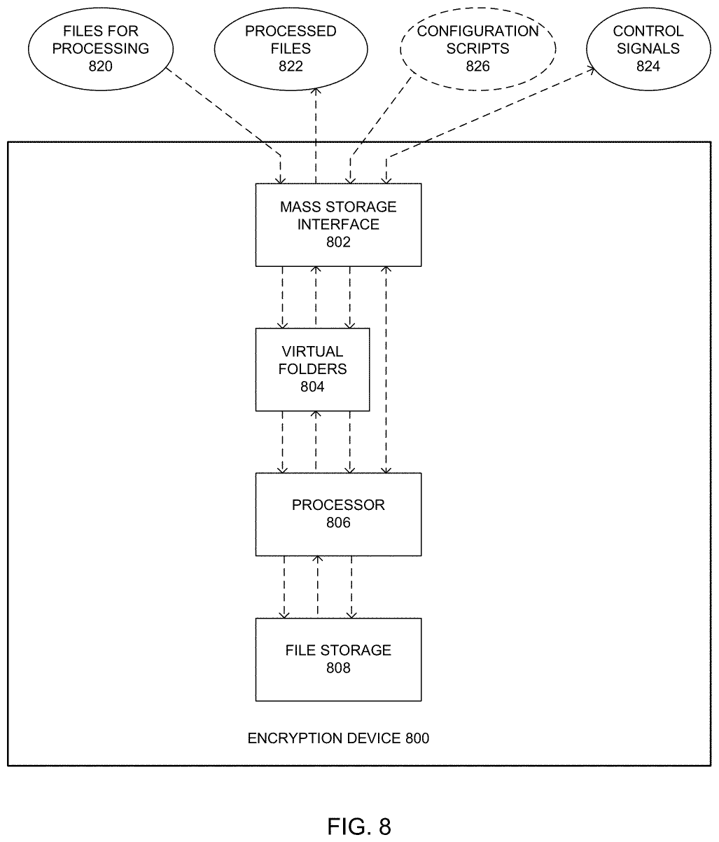

The following description refers to encryption and decryption operations, but it will be appreciated that variants are possible which provide different types of processing, as is described further below with reference to FIG. 8. The operation of the encryption data is described in more detail below.

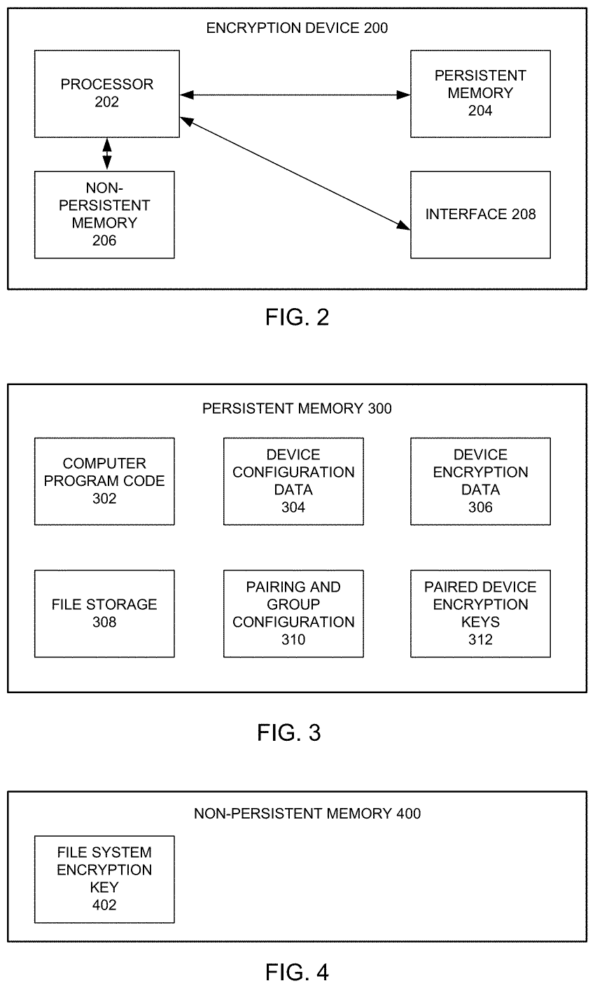

FIG. 2 is a schematic of the encryption device of FIG. 1. In more detail, the encryption device 200 includes a processor 202, one or more persistent memory modules 204 (such as flash memory, hard disk, EPROM, EEPROM and the like), one or more non-persistent memory modules 206 (such as an appropriate variety of RAM, or automatically self-erasing persistent memory), and an interface 208 for connection with a host device.

FIG. 3 is a schematic of the persistent memory module of the encryption device of FIG. 2. The persistent memory module 300 typically includes computer program code 302 for execution by the processor 202 of FIG. 2, device configuration data 304, device encryption data 306, file storage 308, pairing and group configuration 310 and the secret encryption keys 312 of paired devices. Other data may be stored in the module 300 as appropriate and necessary.

The encryption data 306 includes a main encryption key that is uniquely associated with the encryption device. In the preferred embodiment, it is generated by the encryption device itself, for example if the encryption device detects on power-up (or other occasion) that a key is not yet present. In this case, the main encryption key is not known to any other device, and is also not known to the manufacturer of the encryption device. The main encryption key is used to encrypt and decrypt the user's files and to encrypt internal data as needed. It will generally be stored in OTP (One Time programmable memory) within the device.

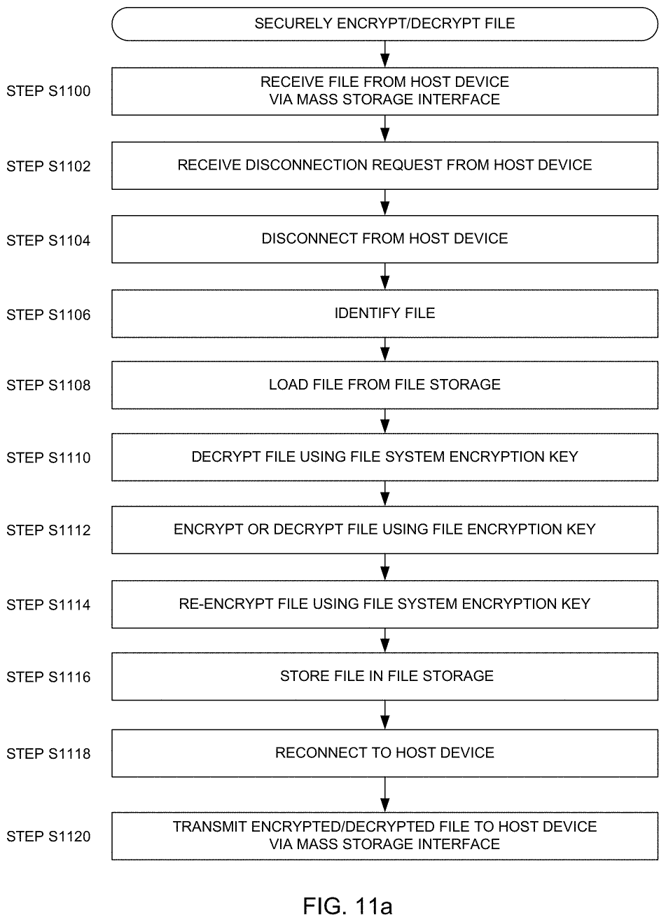

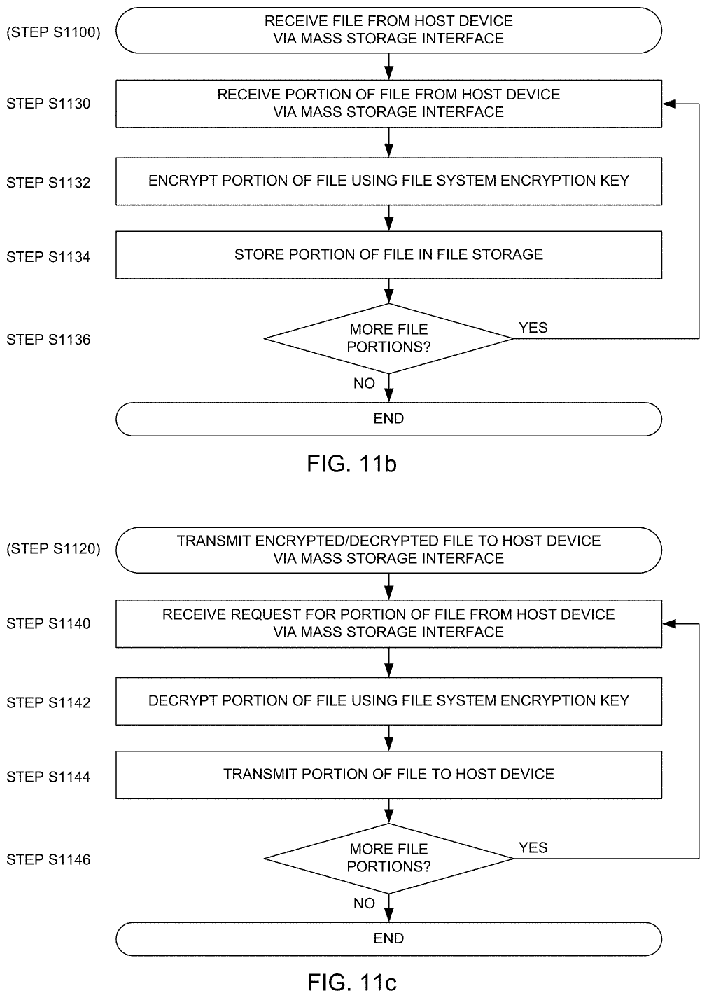

Accordingly, total cryptographic security is provided (initially at least) outside the encryption device itself. In one example described below with reference to FIG. 11, the main encryption key can be ‘backed up’ onto a reprogramming device or similar, to allow an encryption device to be cloned to replicate the original device in the event of loss or technical failure, and so on, but this is entirely optional. If a user never utilises a reprogramming device backup, then if the user initially destroys the encryption device, the user's own files encrypted with it can never be decrypted (except by brute force methods); in this case, the main encryption key never leaves the encryption device. At the time of destruction, any files shared with ‘paired’ encryption devices (see below) can still be decrypted (only) by the paired device, but the shared files can be rendered unreadable if the paired device is also destroyed or reset, or instructed to forget the pairing. A system can be provided if desired to send a communication to a paired device by any appropriate means to instruct the paired device to forget the pairing. Appropriate authentication may be provided (for example using public/private key methods) and the communication may take place automatically, or decryption of shared files may be made dependent on checking with a central server for such communications, and so on.

As is explained in greater detail below, the encryption data 306 may also include a user-specified password or other pass key of any appropriate form (such as finger or voice prints, number combination, other button sequence, and so on) which may be required to operate the device and/or to decrypt any data using the main encryption key (or otherwise). The term ‘encryption data’ in this context may as appropriate comprise authentication data. The keys 310 of paired devices are typically limited only to the main encryption keys of those devices. All of the stored cryptographic data may be further encrypted, for example using the user-specified password or other pass key. By this means, anyone able to compromise the persistent memory 300 of the device would be unable to obtain any secret keys in the clear.

Each element of the memory 300 may be provided in any combination (for example as separate memory units). Certain elements of the memory 300 (such as the computer program code 302 and secret device encryption data 306) may be stored in read-only memory portions of the device so as to minimise the risk of electrical tampering.

Part or all of the memory modules 300, 400 of FIGS. 3 and 4 may be provided with an additional (for example hard-coded) cryptographic interface, only allowing read and/or write operations if appropriate authentication is provided at appropriate moments (for example on power-on and/or connection to a host device) and/or intervals, for example using a public/private cryptography scheme to allow secure authentication even if the authentication messages are intercepted. Such a system could be provided between any two parts of the device architecture, where appropriate. In the preferred embodiment, at least part of the memory modules (for example the computer program code) and processor are provided in a secure package which is destroyed when an attempt is made to open it, preventing electronic intrusion. The processor and program memory may be provided as an integral microcontroller, for example.

FIG. 4 is a schematic of the non-persistent memory module of the encryption device of FIG. 2. The non-persistent memory module 400 includes a file system encryption key 402, which is used to perform a file system level encryption on files sent to the encryption device, as described in more detail below. The file system encryption key is generated randomly by any appropriate method each time the encryption device is powered up, and then stored in the memory 400. Other data, including other encryption keys and/or authentication-related data, or working data, temporary data, and so on, may also be stored in the non-persistent memory as required and appropriate.

The memory 400 is non-persistent insofar as the removal of the encryption device and/or removal of power from the encryption device cause the data held in the memory module 400 (and in particular the file system encryption key) to be wiped automatically. This avoids the risk of any user data in the device being compromised while the encryption device is stored between uses, and so on; files may be stored on the device while it is turned off, but without the file system encryption key they are effectively impossible to decrypt. Other events may trigger the wiping of the memory as appropriate, for example on detection of a physical or electrical intrusion into the encryption device. The file system level encryption scheme typically uses the same encryption algorithm as the main file encryption/decryption (but with a different key) for simplicity and reliability, but for reasons of performance or to save power, a less robust scheme than the main encryption/decryption scheme can be used in order to provide file system level encryption. This scheme will be described in more detail after a brief consideration of the file storage system.

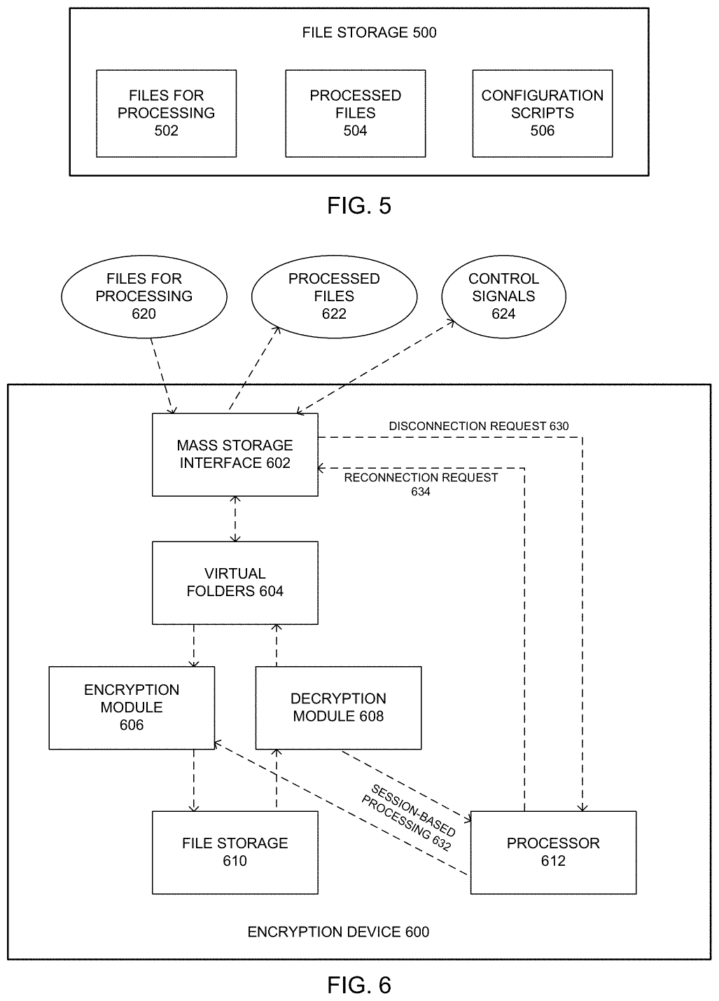

FIG. 5 is a schematic of the file storage module of the encryption device of FIG. 2. The file storage module 500 includes files 502 received from the host device for processing, processed files 504 waiting to be sent back to the host device, and configuration scripts 506 awaiting processing by the encryption device. Other data may be stored in the file storage module 500 as appropriate and necessary.

FIG. 6 is a more detailed schematic of the encryption device of FIG. 1, showing typical data flows within the device. The encryption device 600 includes a mass storage interface 602 (such as a USB mass storage interface), and presents virtual folders 604 via the interface 602. The file system level encryption scheme mentioned above comprises an encryption module 606 and decryption module 608 (provided in any appropriate form, such as separate hardware or software units, or in a single unit by operation of the computer program code executing on the processor) operating as conduits between the virtual folders 604 and the file storage module 610. The encryption device also includes a processor 612 and associated computer program code and other operational data (not shown). The host device (not shown) provides files for processing 620 and received processed versions of the files 622 in return. Control signals 624 are also provided to the encryption device 600 in appropriate forms.

Files 620 for processing are sent to the device 600 via the interface 620 with a destination corresponding to the virtual folders 604 (or virtual subfolders within). By default, the folders are named ‘inbox’ and ‘outbox’ but other variations of naming and structure exist (see below) and are otherwise possible. The device 600 accepts the files 620 using standard mass storage protocols. To the external device it appears as if the files are being stored in the relevant folders in a standard mass storage module. Within the device 600, however, the files are redirected through the encryption module 606, which encrypts the stream of data as it passes through, to an appropriate location in the file storage module 610 with an appropriate (not necessarily identical) file system structure. As many files as needed can be stored in this way, and need not be stored in a persistent fashion and/or in persistent memory or storage. Control signals 624 are also exchanged with the device 600 in accordance with the relevant mass storage standard.

One reason why the file system level encryption is used is because standard mass storage interface protocols (such as USB) do not usually or necessarily transfer individual files in a single transmission, but instead operate at the disk sector (or similar) level, sending chunks of files and not necessarily identifying the start and end of files, nor in particular necessarily identifying that a transfer is complete (that is, confirming that the portions received of a file are necessarily the totality of that file) and so on, such that, firstly, at some points only part of a file will be received (so whole-file encryption is not possible) and, secondly, that even when the whole file has been received, this cannot be known with certainty until and unless a disconnection signal has been received (indicating that file operations are completed). Thus the file system level encryption (encrypting each sector and the like individually) ensures that all data is encrypted at all times while stored in the device, even while file transfer operations are in the process of completing.

The control signals 624 include a disconnection request 630 sent to the device 600. In the preferred USB standard, this comprises an ejection request. On receipt of this request 630, the processor 612 (or any other appropriate means) implements the disconnection protocol of the relevant mass storage device, such that the device 600 remains physically connected but electrically disconnected (virtually, or actually) from any host device. It is also possible for the steps described herein to be carried out after a physical disconnection, for example in conjunction with an appropriate internal or external power supply, or without any electrical/software disconnection taking place (though this is preferred for security reasons). After the disconnection has taken place, the processor 612 then carries out an appropriate session-based processing 632 of the files (in this case, encryption/decryption) in the file storage 610. The file system level encryption and decryption modules 606, 608 continue to be used to ensure that any processed files are not stored (even temporarily) in the clear. In the preferred embodiment, files for processing (either encryption or decryption depending on the file type) are placed in an ‘inbox’ folder, and files once processed are placed in an ‘outbox’ folder (with the original files preferably deleted after processing, so the effect is essentially to move the file from the inbox to the outbox). In a variant of the preferred embodiment, files remain where they are, or are placed in a single folder which may have its name changed to reflect the processing has finished, and so on.

The specific type of processing carried out on each file may be determined by any appropriate means. In the specific case of encryption, the choice of encryption or decryption operation is selected on the basis of the file type of the file (because encrypted files are identifiable on that basis). Other methods of selecting the processing choice are of course possible, such as based on an analysis of the content of the files (looking for standard markers, and so on), or by a control signal of some sort sent by the host device in the form of a message or a file, and so on.

When the processing is complete, the processor 612 sends a reconnection request 634 to any connected device to cause the virtual folders 604 to reappear on the connected device. This can act as a prompt to a user to retrieve the encrypted or decrypted files. In a variant it may either be not possible or not desirable to send a reconnection request 634. In another variant, the disconnection request 630 is some other form of control signal 624 sent via the mass storage device interface 602. In a yet further variant, the disconnection request is sent in the form of a file with a special filename or content, potentially avoiding the need to monitor or use any control signals beyond the minimum required to establish a connection. In another variant, the disconnection request is sent other than via the mass storage interface 602, for example via a local area or wide area network connection, Bluetooth® or similar interface, optically or acoustically (to allow decoupling from network or electrical connections), or via any other wired or wireless interface. The same is true of any other data items which are transferred in either direction between the encryption device and a host device.

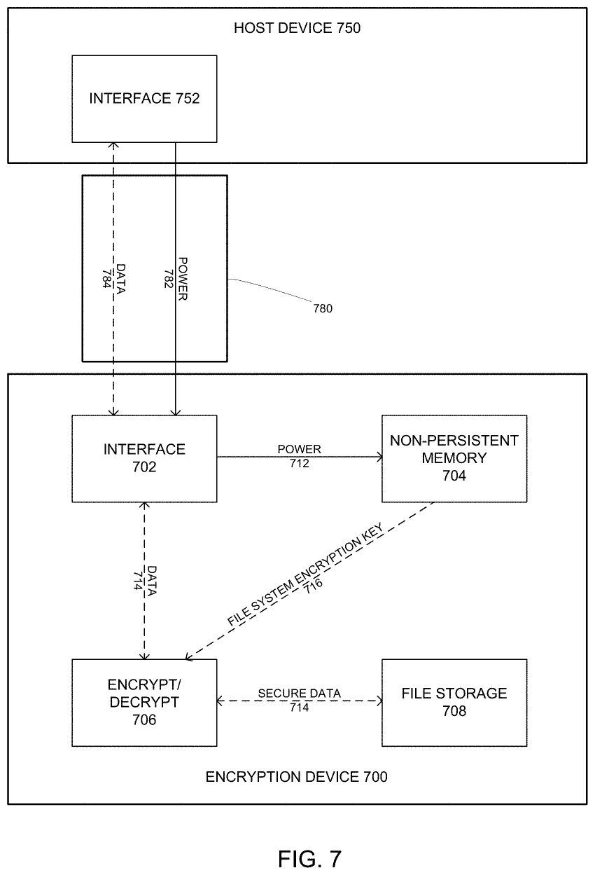

FIG. 7 is another schematic of the encryption system of FIG. 1, illustrating signal and power connections. The encryption device 700 (or general purpose or other specific purpose processing device) includes the interface 702, non-persistent memory 704 as described above, an encryption/decryption module 706 (which is typically embodied in a processor and associated memory), and file storage 708 as described above. The host device 750 includes an interface 752 as described above, and is connected to the encryption device 700 via a wired link 780. The wired link 780 is preferably not (or minimally) susceptible to electronic or physical intrusion and preferably does not produce a large amount of electromagnetic radiation. Accordingly data passing via the link 780 is relatively safe from interception, making it an appropriate conduit for passing unencrypted data between the host device 700 and encryption device (such as files being sent for encryption, and files being received after decryption). The link 780 includes a power connection 782, supplying power to the attached device 700, and a (relatively safe from snooping) data connection 784. Internally, the encryption device 700 forwards on power to the non-persistent memory 704 and forwards data to the file storage 708 via internal power 712 and data 714 conduits respectively, which (as described above) may pass through one or more intermediate devices and modules (such as the encrypt/decrypt module). In the preferred embodiment, the non-persistent memory 704 loses all data as soon as it loses power.

The advantage of the system shown in FIG. 7 is that any removal of the encryption device 700 or any removal of the link 780 will automatically cause all data in the non-persistent memory 704 to be erased. In this configuration, no active steps need to be taken by the encryption device 700 or host device 750 to achieve this. Though the files in the file storage 708 may be retained after losing power, the lack of the file system encryption key 716 renders them effectively useless. However, in variants of the preferred embodiment, the files are also deleted (either manually, or by virtue of being stored in non-persistent memory also, as described in more detail later).

In variants, the non-persistent memory 704 may not automatically erase all data on power loss (that is, it could be persistent memory of some sort with an appropriate controller attached to provide the non-persistent behaviour). In this case the memory 704 may be configured to wipe all data on detection of a power loss or other appropriate event; in these variants typically some other form of power supply is required (such as a capacitor, rechargeable battery, or similar device powered by the power line 712 to store a small amount of charge to allow a short period of operation after power loss). Since the non-persistent memory need store only a single encryption key (typically 256 bits), this provides the advantage that only a small amount of charge/memory access is needed to complete the deletion, regardless of how many files are stored and how big the persistent storage is. As noted above, the non-persistent memory can be controlled to wipe the data in response to other events, such as detecting physical or electrical intrusion.

Notwithstanding the automatic erasure of user data mentioned above, at least one secret key is required to be stored on the device for encrypting and decrypting the user data. Accordingly appropriate physical security should be provided for the encryption device (whether in use or not) to prevent it being used for unauthorised decryptions (although it is possible to provide more additional security to protect it more completely, for example decrypting it using a user-supplied passcode or similar which is not stored on the device). On the other hand, since encryption and decryption operations are typically only carried out when the encryption device is electronically disconnected from the host device, the device is less susceptible to electronic attack.

FIG. 8 is another schematic of the encryption system of FIG. 1 illustrating signal flows. The encryption device 800 includes a mass storage interface 802, virtual folders 804, a processor 806 and the file storage 808. As before, files 820 for processing and processed files 822 are sent and received, and control signals 824 are exchanged. In addition, configuration scripts 826 can be delivered to the encryption device 800. The data flows within the encryption device 800 are indicated by directional dashed lines: files 820 for processing and processed files 822 pass through the virtual folders 804 as before, into and out of the file storage 808 as described above. Control signals 824 pass directly between the mass storage interface 802 and processor 806. The configuration scripts 826 exist in the form of files which are transferred into the virtual folders 804 in the same fashion as the files 820 for processing. Initially the configuration scripts 826 are placed in the file storage 808 along with the files for processing. Later, after the device is disconnected and the processor 806 initiates the session-based processing (in this case, encryption and/or decryption), the processor 806 detects the configuration scripts 826 and processes them separately. Typically the configuration scripts 826 cause the processor to change configuration data within the device 800, causing the processor to write to (and in some cases read from) the persistent memory store (not shown), to update the configuration (or other) data. Configuration scripts can for example change the virtual folder structure, change the encryption method being used, and so on.

Configuration scripts can be identified by one or more of: a file type, a naming convention, standard headers and/or markers within the file, a reference to the script within another configuration script or standard file or other identifier, or any other property or direction from the host device or otherwise. Typically, configuration scripts have a text file type (.txt or similar) and a standard name. For example, a new password can be set in a file having the standard name ‘password.txt’. In addition, validation may be carried out on the file contents before any configuration data is written. In the present example, the new password must be provided twice, identically, before it is processed (and if changing the password, the old password must be provided as well).

In most cases, configuration scripts are deleted after processing, but they may remain in place and/or be permanent fixtures within the virtual folder structure. The password file is one example of the latter (though this feature can be varied according to preference); in that case (as potentially with others), the contents of the file are wiped after processing but the empty file remains (as a prompt for the user, for example).

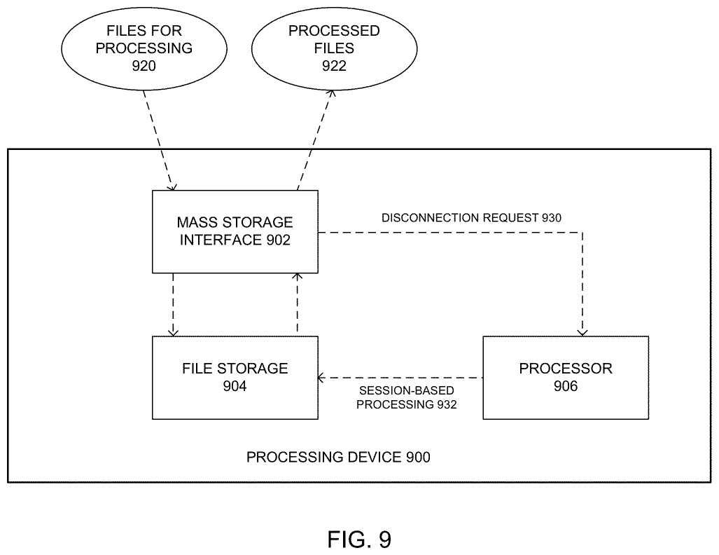

FIG. 9 is a schematic of an embodiment of a processing device similar to the encryption device of FIG. 1. The processing device 900 includes a mass storage interface 902, file storage 904 (which may be as described above or otherwise) and a processor 906. As before, files for processing 920 and processed files 922 are received and sent, with the files for processing being stored in the file storage 904 while awaiting processing. On receipt of a disconnection request 930 transmitted in any appropriate fashion (as mentioned above), the processor 906 carries out any appropriate or desired session-based processing 932. The ‘session-based’ qualifier merely entails processing carried out over a finite time (predetermined or otherwise) relying on the knowledge that no changes will be made to the files in the file storage 904 (for example by continued operation of the mass storage interface). Operating using the principles described above and below, such a device 900 can in a similar fashion provide transparent processing of files handled using standard mass storage protocols (easy drag-and-drop using standard interfaces, and so on), and allow session-based processing of a selection of files without requiring any additional hardware or software components in a host device.

Typical session-based processing tasks which the device 800 can provide may for example include compressing files, ‘burning’ the files to a CD, DVD or any other write-once (or write-many) medium, packaging the files for distribution or otherwise, spell-checking the files, backing up the files to a less accessible storage device, initiating a text-to-speech or other output session, or carrying out any task which is not typically feasible to do in real-time or which is desired to be carried out using supplementary hardware (such as the processor of the processing device 900) rather than using internal resources of the attached host device (for the sake of performance, and so on). Essentially any processing operation can be carried out which is suitable either to operate on, or be programmed by, one or more files copied over from a host device. This method is useful for, but not limited to, session-based tasks where the integrity of the file structure and file contents can be assumed to be constant.

The present embodiment may also include any or all features described above. The preferred version of this embodiment uses the virtual folders feature, for example. In all embodiments, the virtual folders can serve purposes beyond redirecting files to non-persistent (or other types of) storage and configuring the device. For example, as will be described in more detail below, the virtual folders can be used to carry out immediate actions on files which are sent to them.

The description above discussed files transferred to and from the virtual folders by a host (or other) device, but it is possible also to move files around within the virtual folders. For example, files can be deleted by dragging them onto a deletion-operation virtual folder (for example called ‘_DELETE’). Folders carrying out actions can for example be identified by a custom naming convention, such as all capital letters and a ‘_’ prefix, for example, though other conventions are of course possible. Other operations include displaying the configuration of the device by means of folders (for example describing the pairing data, see below) and changing the configuration by means of folder operations (such as dragging files between such folders, dragging such folders into other such folders, and dragging folders onto delete-action folders, for example with the effect of destroying existing pairings). Again, this allows relatively sophisticated and essentially arbitrary behaviour to be provided simply by means of standard massage storage protocols and user interfaces. As well as creating custom folders, the device can also create custom files containing any appropriate data for transferring back to the host device or user of the host device.

The folders are virtual in the sense that they do not correspond directly to a directory structure of a storage device, or at least to a persistent mass storage device. The folders may additionally or alternatively be considered virtual in the sense that they are dynamically and/or procedurally generated. Additionally or alternatively, they may be considered virtual in the sense that they are associated with processing operations, eventually (on disconnection) and/or immediately (deletion). The folders may also be considered virtual in the sense that (typically) at least one of the folders is associated with an action and/or does not result in the storage of files dropped within it, even temporarily.

While it is possible to use the device without any additional user interfaces or control schemes, it may in some cases be desired to provide ‘helper’ applications which can automate, simplify or conceal any or all of the operations mentioned above using standard (or otherwise) programming features in standard operating systems including, but not limited to, Linux (and other UNIX® variations), Windows® and Apple® operating systems. Such applications (or other software components) can for example provide a user interface to provide configuration options for the encryption/processing device. Any configuration changes made by the user could then, for example, be generated into an appropriately named/tagged configuration script and automatically sent to the device. A disconnection request may be automatically sent. If not, the user may be prompted to disconnect the device at the first opportunity. The helper app can also help the user manage encryption and decryption operations, manage pairing, or other processing operations, and so on. The helper app may be provided elsewhere than on the host device and may, as appropriate, communicate via the host device and/or the encryption/processing device, either via the mass storage interface and/or protocol, or otherwise.

In a variant of either main embodiment, password protection and/or file system level encryption may be provided partly or wholly on the host device (or providing a duplicate system to that described above relating to the encryption/processing device, for example under the control of the/a helper app.

The configuration data and/or pairing structure (or any other persistent data) in the encryption device may be backed up as appropriate. Backup data may be stored as a virtual file (which is only generated when copied off the device) or generated on request (for example in response to a configuration script). The backup data may even include cryptographic data. In that case (or otherwise), in order to avoid cryptographic compromise, the backup data is preferably encrypted using a main encryption key or similar. Accordingly, if the encryption/processing device fails, it can be fully restored by a combination of the main encryption key and the backup file, and the backup file can be stored as part of a normal backup process without the need for additional data security. The process can be assisted or automated using a helper app as mentioned above.

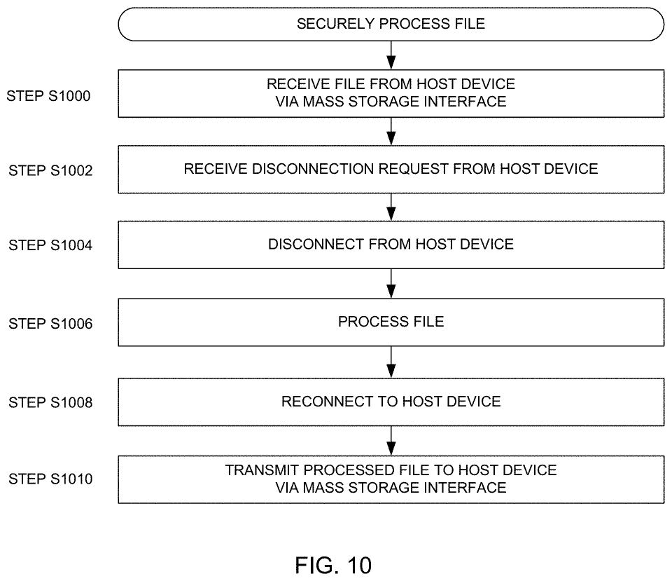

FIG. 10 is a flow chart of the process of securely processing a file using the device of FIG. 1 or FIG. 9. This flow chart essentially summarises the processes described above. In step S1000, a file (or files) is received from a host device via the mass storage interface of the encryption or processing device. In step S1002, a disconnection request is received from the host device, for example in the form of a USB ejection request. Consequently (S1004) the encryption or processing device disconnects from the host device (in some cases in some protocols this action may be carried out by the host device). The file (or files) is processed (step S1006) and the connection to the host device is re-established (step S1008), either initiated by the encryption/processing device, by the host device, or by the user of either device. Once the connection is re-established, the processed file(s) is transmitted to the host device via the mass storage interface (step S1010), in response to a standard mass storage read request from the host device (in typical mass storage protocols the host device is the agent initiating the transfer, although in a variant this need not be the case); references to transmitting files to the host device should generally be understood within this context. It will be appreciated that all of these steps may, where appropriate: be omitted, be provided independently, be provided in a different order or be supplemented by additional steps (as mentioned above or otherwise). Steps and features described as relating to encryption-specific devices may where appropriate also relate to more general processing devices, and vice versa.

FIGS. 11a to 11c are a flow chart of the process of securely encrypting or decrypting a file using the device of FIG. 1. In step S1100,

In step S1100, the encryption device receives a file from a host device via a mass storage interface and stores it in the file storage with file system level encryption, as is described below in more detail in relation to FIG. 11b. After a disconnection request is received (S1102), the encryption device disconnects (or is disconnected) from the host device (S1104). After disconnection, the file (or files) is identified by analysis of the data received from the host device (essentially, ‘mounting’ the file system), in step S1106. The file is loaded from file storage (S1108) and decrypted using the file system encryption key (SS1110). These two steps are typically combined in a single call to the internal file system. The file is decrypted portion by portion and/or sector by sector, if need be, using the file system level key (S1114) as it is read out of storage.

The file is then either encrypted or decrypted using a second key (the main encryption key mentioned above, typically) in step S1112. The processed file is then re-encrypted with the file system level encryption key (S1114) and stored (S1116) back in the file storage (typically in persistent memory). The encryption/decryption can be carried out sector by sector/portion by portion (requiring relatively little working memory to do so, but taking longer) or preferably as a single file operation (requiring either relatively large amounts of working memory, or caching to the file storage, with a security disadvantage). Typically the file system level encryption is transparent as far as the encryption/decryption session is concerned, so that the encryption/decryption process is free to use the file storage area without itself taking care of the file system level encryption so as to ensure no data is stored in persistent storage even temporarily in the clear.

After the device re-connects to the host device (S1118), the processed file is transmitted back to the host device (S1120), in response to a user dragging it out of the virtual folder, for example.

The step of receiving the file from the host device (S1100) will now be described in more detail with reference to FIG. 11b.

In step SS1130 a portion of a file (such as one or more sectors of the virtual mass storage device advertised to the connected computer by the encryption device) is received from the host device via the mass storage interface. It may be that the portion is in fact the complete file, but in typical mass storage standards the recipient device does not receive a notification of this and this cannot be determined via the mass storage protocols. In a variant of the preferred embodiment, real-time information on whether complete files have been received is determined heuristically, for example with reference to known properties or data patterns and structures of particular file types, but this is not possible for all possible file types.

The received portion of the file (that is, the received disk sector, or similar) is encrypted (S1132) using the file system level encryption key. The file system encryption key is typically generated at power-on of the device, or otherwise prior to initialisation of the file storage, since this typically requires the use of the file system key. As mentioned above, the file system encryption key is not stored in persistent storage and is not accessible after the device is disconnected. Overall, the file system encryption key is generated once per ‘plug-in’ event.

For efficiency, the same encryption routine, such as AES/Triple DES and so on, and the same key size (such as 256 bits) is used for both the file system encryption and the per-file encryption/decryption, but a more efficient (and possibly less secure) algorithm could be used if required, bearing in mind the reduced expectations for security arising from the fact that any decrypted files in the encryption device will either have originated from the attached device (where they are likely stored in the clear) or will soon be transferred to it, so it may be permitted for the data security for file system level encryption to be lower than for the encrypted files themselves, which are expected to be transmitted via unsecure channels to remote devices. That is, the encryption standard for the files (rather than file system) must be paramount, but preferably the same (high) level of encryption is used system-wide.

After file system level encryption is complete, the file portion is stored in the file storage module (S1134) in encrypted form. If the host device transmits more portions of the file, the process is repeated (S1136).

The step of transmitting the file to the host device (S1120) will now be described in more detail with reference to FIG. 11c. Essentially this process is a mirror of the reception process described in relation to FIG. 11b.

A request is received (S1140) via the mass storage interface for a portion of a file from the virtual filing system. The request is low level and does not identify a particular file. In contrast to receiving file portions, it is possible to determine when all portions of a particular file have been transmitted. Accordingly, in a variant, on detection that all portions of a file have been read by the host device, the relevant file can be deleted. This can add some processing overhead and may be considered undesirable behaviour by a user, however.

The file portion is decrypted using the file system level key (S1142) as it is read out of storage. The portion is then sent to the host device (S1144). As it can be observed, at no point does the file exist in unencrypted form in storage in the encryption device. (Encrypted files awaiting decryption, and encrypted processed files will be double-encrypted while stored, but this does not present any technical disadvantages.)

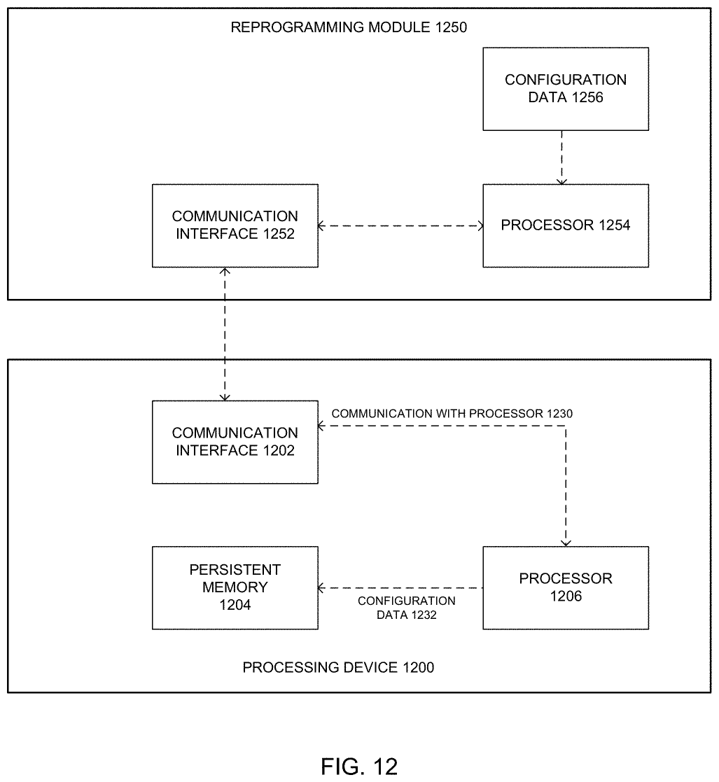

FIG. 12 is a schematic showing a reprogramming module attached to the device of FIG. 1 or FIG. 9. The processing device 1200 includes a communication interface 1202, persistent memory 1204 and processor 1206. The reprogramming module includes a communication interface 1252, processor 1254 and configuration data store 1256.

In the present embodiment, the communication interface is a second USB interface, allowing the reprogramming module to be plugged into the encryption device while the encryption device is plugged into a host device. This obviates the need for either the encryption device or reprogramming module to have an internal power supply. Alternatives are discussed below.

When the reprogramming module 1250 is connected to the processing device 1200, the module 1250 communicates 1230 with the processor by any appropriate means and transmits at least a portion of the configuration data 1256. The processor 1206 is then caused to update the persistent memory 1204 with configuration data 1232 received from the reprogramming module. Validation and authentication (for example using public/private keys) is typically carried out. In the case of encryption devices, the reprogramming module transmits at least the main encryption key so as to create a clone of the original device it was associated with, although other or further configuration data may be transmitted as part of the process. Thus if an original encryption device is lost, destroyed or non-functioning, a replacement encryption device can be created using the reprogramming module. In the preferred embodiment, the reprogramming module deletes part of all of the stored configuration data (and especially any encryption keys) so that further clones cannot be created without (if possible) explicitly reprogramming the key into the reprogramming module from the new clone (requiring the explicit confirmation of, and at the sole initiative of, the user).

In the present embodiment (such as via configuration files or control signals) the USB Communications Device Class (CDC) protocol is used to communicate between the reprogramming module 1250 and the processing device 1200, but other protocols are possible, such as the mass storage protocol (see below), TCP/IP, and so on. In terms of physical interface, the USB (mass storage) interface is used for convenience, but any appropriate interface could be used, such as a serial port, Firewire connector, Ethernet connector, and so on. Wireless connections are also possible, via Wi-Fi, Bluetooth, and so on, but are not preferred, since they do not have many of the advantages already mentioned of the physical USB connection. Other protocols may be used, such as JTAG, SCSI, and so on, which have both physical and non-physical aspects.

Because of the potential to create unwanted decryption devices, preferably the reprogramming module is treated with the same degree of security as the encryption device itself (and preferably kept in a separate location). Though this imposes a need for physical security, it provides a means to reactivate an encryption device with an original key without having to involve any third parties or the manufacturer of either device (neither of which have access to, let alone store, any secret keys), which provides a key reset mechanism with overall considerable cryptographic security.

The user and/or manufacturer can alternatively either destroy, not program with a key, or simply not produce a reprogramming module. This provides the greatest cryptographic security (only one key exists inside the encryption device initially) but if the original encryption device fails, the files which it encrypted become forever unreadable.

In the preferred embodiment, the manufacturer provides both the encryption device and reprogramming module to a user, with both having a unique and synchronised main encryption key (amongst others), but the manufacturer does not store the key. This provides the greatest efficiency and simplicity for the manufacturer, but in a variant of the preferred embodiment, the main encryption key is generated by the encryption device at an appropriate point if it is detected that no such key yet exists. For example, at first power-on, if the encryption device detects no key present, then the key is generated and stored in the secure persistent memory within the encryption device. In one variant, that key can be transferred to a reprogramming module for later use by any appropriate means and at any appropriate time, for example via an intermediate host device and/or network connection.

In another variant, the main encryption key is generated at first power-on or similar, and is not ever transmitted outside the encryption device. By way of exception, if there is a reprogramming module connected to the encryption device at the time of key generation, then the key will be securely transferred to the reprogramming module, which can then be removed and stored for later use. Further variations are of course possible, balancing cryptographic security with ease of use. In this case, there may exist means (such as a configuration file or reset button) to cause a ‘factory reset’ of the encryption device so as to make it lose any existing main encryption key. Thus a user can be assured that none of the manufacturer or a previous user or owner of the device has any access to the main encryption key, for increased cryptographic security.

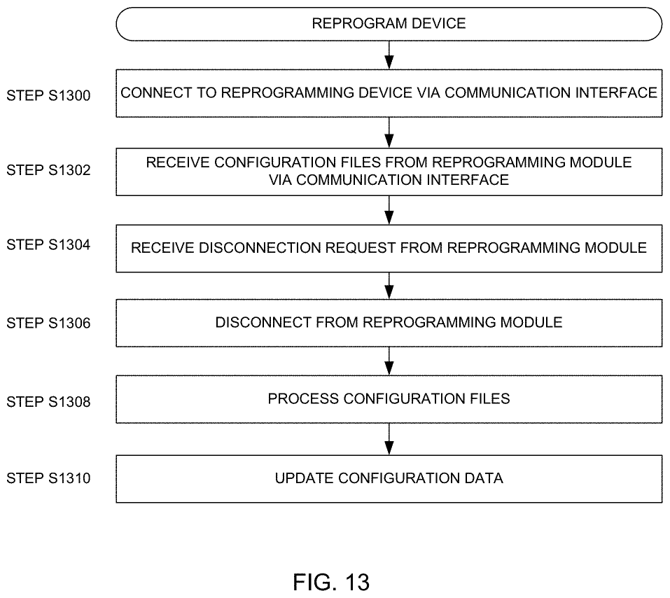

FIG. 13 is a flow chart of the process of reprogramming the device of FIG. 1 or FIG. 9 with the reprogramming module of FIG. 12. The encryption device connects (S1300) to the reprogramming device via a communication interface. In the present embodiment, a female USB interface provided on the encryption device receives a male USB interface provided on the reprogramming device, but other arrangements are possible, for example via an intermediary device which may effect any appropriate combination of male to female adaptors and/or supply power. In the present embodiment, the encryption device is simultaneously plugged into a host device or USB power source, but power may be supplied in or through either the encryption device or reprogramming module via any other appropriate means. Configuration files are received (S1302) from the reprogramming module via the communication interface. Then, as is customary, a disconnection request is received (S1304), the module disconnects (S1306), and then the configuration files are processed (S1308) and the configuration data in the processing/encryption device is updated (S1310).

Typically the CDC protocol is used to communicate between the encryption device and the reprogramming device. Variants may use the mass storage device protocol, at least to initiate communications, but the CDC protocol is preferred because it is designed for two-way general data communication and is more flexible than the mass storage protocol.

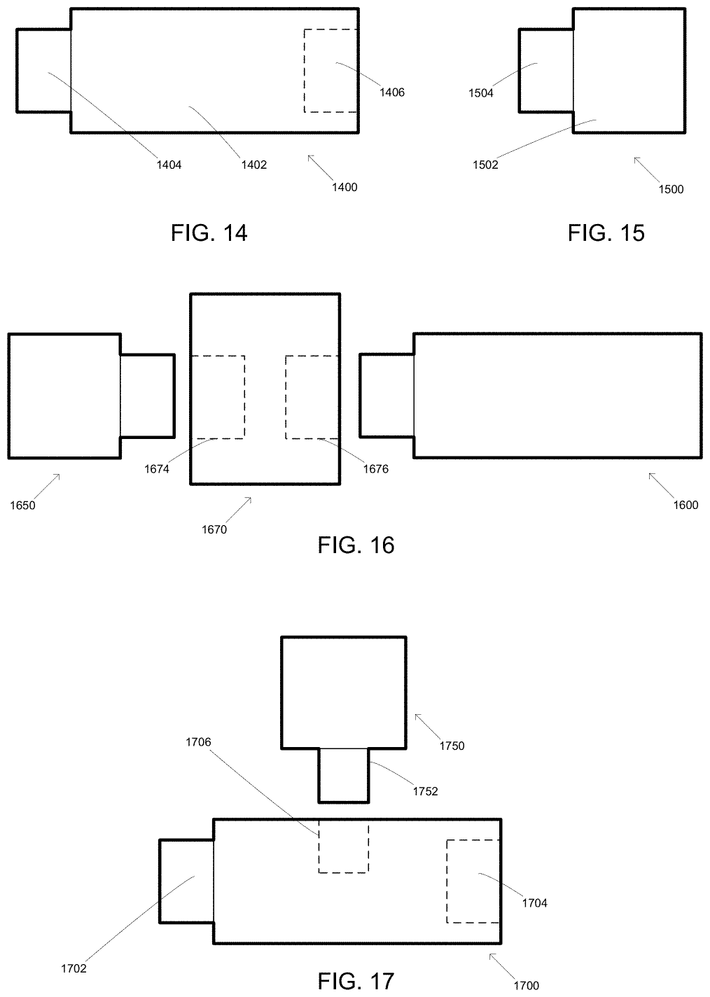

FIG. 14 is an illustration of the device of FIG. 1. The device 1400 is provided in the form of a ‘USB stick’ mass storage drive. It includes a main body portion 1402 enclosing the electronics and storage systems described above, a male USB connector 1404 for insertion into a USB port in a host device or USB hub attached thereto, and a female USB port 1406 for receiving another such device 1400 (for pairing, see below), or a reprogramming module (see below). Other arrangements of ports or package types are possible, and other features can be incorporated within the body portion 1402, such as security features (such as fingerprint scanners, other biometric inputs, or security keypad or buttons, and so on), status and/or progress indicators (such as LEDs, loudspeaker, and so on).

In an alternative embodiment, the device is provided in the form of an SD/MMC or other memory card. Or package types, sizes and protocols are of course possible.

FIG. 15 is an illustration of the reprogramming module of FIG. 12. The module 1500 includes a main body portion 1502 enclosing the electronics and storage systems mentioned above, and a male USB connector 1504 for connecting to an encryption device 1400 mentioned above. Other arrangements are possible, including different packaging types, shapes and sizes, and different port arrangements. A female USB port could be provided instead of the male USB connector, for example, which means that an additional power supply is needed to allow the reprogramming. This can either be by means of an additional male USB connector (for the sole purpose of obtaining power) or another power means such as internal (battery) or external (mains transformer) power supply. In the latter case, the extra inconvenience is offset by increased cryptographic security, as neither the encryption device nor the reprogramming module are physically or electronically connected to any other computing device.

FIG. 16 is an illustration of an alternative connection arrangement of the encryption device and reprogramming module. The encryption device 1600 and reprogramming module 1650 interconnect via sockets 1674, 1676 in an intermediary device 1670. In this case, the encryption device may or may not have a second USB interface for pairing. The same intermediary device 1670 can be used also to pair two keys together without the need for a second interface on each. Either the intermediary device 1670 connects via a separate connector (not shown) to a host device as before, or only serves to provide power to the attached devices, for example using an internal power source (such as a battery) or via appropriate connection to external power. The intermediary device may alternatively have male connectors and the encryption device may be provided only with a single female USB connector, and so on.

FIG. 17 is an illustration of a further alternative connection arrangement of the encryption device and reprogramming module. Previously the reprogramming module has used the same interface as is used for pairing and/or connecting to a host device, but in this variant, the encryption device 1700 is provided with the two USB sockets 1702, 1704 as before (one still being optional) and also an additional interface 1706 of a different type, to which a connector 1752 on the reprogramming module 1750 connects. As before, male may be switched with female as appropriate. In all cases, a separate wire/lead or other appropriate intermediary equipment may be used to connect the devices (whether for pairing or reprogramming) rather than relying on direct connections, though direct connections are of course preferred for reasons of cryptographic security.

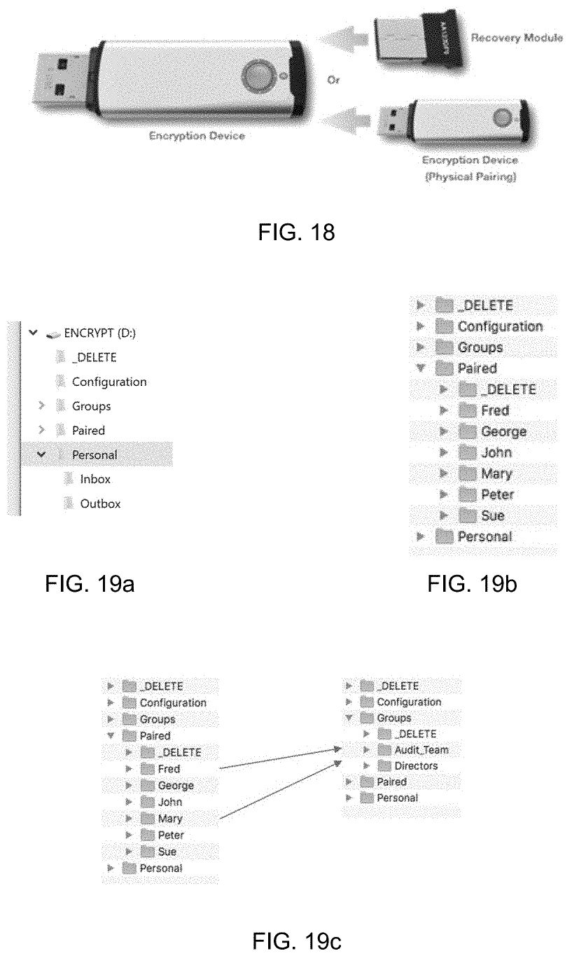

FIG. 18 is a further illustration of two devices of FIG. 1 and the reprogramming module of FIG. 12, showing packaging options for the encryption device and reprogramming module. It can be observed that the devices have an indicator LED and also a disconnection button, which forces a disconnection from the host device (and, consequently, immediate processing of any transferred files). The button can be used also or instead to cause a re-connection to the host device, or to carry out any other function (such as causing a factory reset of the encryption key, and so on, if pressed in a specific and not easy to accidentally reproduce fashion).

The operation of the encryption device embodiment, and in particular the management of the encryption device from the host device perspective, and the use of a pairing process to allow the transmission of encrypted data to additional users and devices, will now be described in more detail in a more specific embodiment. It will be appreciated that any or all of the foregoing features may be added to or substituted for any other features of this specific embodiment, with any degree of generality. It is envisaged that all features described herein may be provided independently of each other and in any appropriate combination, providing that they are not technically incompatible. A discussion of two or more features in combination is not intended to imply that they are necessarily technically related or must be provided in that (or any other) combination.

In summary, hardware encryption devices are proposed that must be paired in order to transfer encrypted data between them. These devices can encrypt files for secure transmission to one or more recipient, or for general storage in the cloud. No data is stored on the devices. Custom software is not required to use them. The device features include:
The devices look and act much like USB memory sticks.
Encryption/decryption of files is performed by a ‘drag & drop’ process.
Passwords are not required, but can be used to further restrict device access.
No file data persists on the devices. Any data persistence required for device management is encrypted.
No software is required on the user's computer. The device manages everything internally—although a helper application could be employed to simplify use.
Multiple devices are initially paired by literal physical connection (highly secure): they are plugged together and communicate via an encrypted protocol.
Where physical pairing is impractical, devices can be (initially) paired via a secure web service. This original pairing may then later be updated (peer-to-peer) to establish a relationship entirely independent of the web service.
Multiple devices may be paired in multi-way associations (one-to-many or many-to-many) to facilitate secure transfer between groups.
Devices may not be directly cloned.
A separate ‘recovery module’ is provided with each device, which may, optionally, be initialised and then retained in a safe place in order to create a clone of the original device in the event of loss or failure.

As described above, the product is comprised of two components:

(1) The Encryption Device resembles a USB memory stick. This device performs all encryption/decryption and management operations in highly secure hardware, without requiring any drivers or other OS software. The device emulates a mass storage device (flash drive) such that all user interactions are (normally) via a familiar File Manager interface. Device operations are triggered by copying of files to the device followed by an OS request to unmount (eject) the drive. The ejection request is easily issued through a sub-menu operation in most operating systems, or a physical button on the device. Once ejected (but still physically connected to the computer), the device will perform the necessary operations prior to automatically re-mounting and displaying the results—such as a number of decrypted files being available.

The Encryption Device does not persistently store any files. Any data required for device operation are encrypted, with cryptographic keys being stored in a highly-secure manner. At the rear of the device is a USB socket into which a second Encryption Device may be plugged for pairing via an encrypted protocol. The socket is also used to attach the supplied Recovery Module. An LED on the device provides a visual indication of its status.

(2) The Recovery Module (reprogramming module): in the event of loss or failure of the Encryption Device, the Recovery Module facilitates the generation of a clone device, such that previously encrypted files may later be accessed and device pairing restored. A highly secure matched recovery module is supplied with each encryption device. The module cannot be connected directly to, or read by, a computer as the protocol is encrypted. It is only intended for temporary connection to a replacement Encryption Device to create a clone by restoring the highly sensitive security credentials.

When connected to the original Encryption Device, the recovery module will take on the volume name of the encryption device to aid subsequent identification. In addition, a unique ID number is printed on each module. The Recovery Module must be stored separately in a secure location if a disaster recovery option is required; but some users may choose not to use the module.

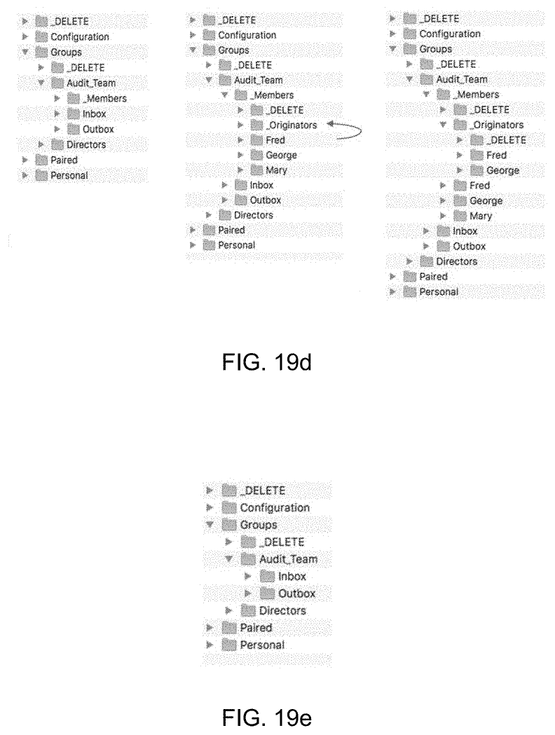

To encrypt and decrypt, the user must first plug the USB encryption device into their computer. The device will initially appear as a normal USB storage device with several folders at the root level. One of these is a ‘Personal’ folder containing two empty folders: Inbox and Outbox. FIG. 19a is a screenshot of such a set of folders.

To encrypt the user simply drags or copies the required file(s) into the Inbox folder. Once copied, the user must unmount (eject) the device (not unplug): either from within the operating system or using the helper application. The device will then disappear from the available drives on the computer, but will re-appear after a short delay when it automatically remounts itself. All files that were previously in the Inbox folder are now available in the Outbox folder with a ‘.sd’ file name extension appended to signify the encrypted version. The original Inbox files will have been removed. The encrypted file(s) may then be copied or sent anywhere the user wants, safe in the knowledge that they may only be decrypted by the original device.

Exactly the same process applies for decryption. Whenever encrypted files are placed in the Inbox they will appear decrypted in the Outbox once the device has been ejected and remounted. Once the user has copied off any files placed in the Outbox, the device should be unmounted and may then be removed. On physical re-connection, both Inbox and Outbox will always be empty as no file data are permanently stored on the device. It is possible to encrypt some files and decrypt others simultaneously. The encryption and decryption process is similar for pairs or groups of devices; who each have their own Inbox and Outbox.

Whilst the primary purpose is to facilitate secure data transfer between paired devices, the device may be used in a standalone fashion—to secure files prior to external storage (such as a cloud service). When used in this manner, it is imperative (for most users) that the Recovery Module is configured and securely retained, to guard against the possibility of being unable to decrypt files should the device be damaged or lost.

Each device and associated Recovery Module have a matched, highly-secure internal ID. In addition, each Encryption Device has a unique factory default volume name, which appears when it's plugged in to a computer. This volume name would ordinarily be changed to something more recognisable (just like any other drive).

To establish physical pairings between two devices the following process is followed:

1. Plug the device you wish to pair with (slave) into the back of the (master) device.
2. Plug the piggybacked pair into the computer, or a USB power supply
3. The master device appears as a drive on the computer as usual. On this drive, a new folder will have been created within the ‘Paired’ folder with the volume name from the slave device containing an Inbox and Outbox unique to this pairing. Conversely, a similar folder structure will be created on the slave device named after the master.
4. Unmount (eject) and then separate the newly paired devices.

The term ‘pairing’ is used herein for consistency, but related/connected devices may also be referred to as ‘contacts’ or by any other appropriate name, for example.

FIG. 19b is a screenshot of a suitably configured set of paired devices, as displayed in the virtual folder structure.

Each device may be paired (one-to-one) with multiple devices with a unique folder set created for each pairing. Numeric suffixes will automatically be added to avoid name clashes where required. The Inbox and Outbox inside the named folder behave in exactly the same manner as the user's personal Inbox and Outbox. The significant difference being that a file encrypted here can not only be decrypted using the named Inbox, but also on the paired device's corresponding Inbox.

A pairing may be removed from a device by simply dragging the named folder onto the ‘_DELETE’ folder—visible in both the ‘Paired’ and root folders. That device will no longer be able to read files previously encrypted by the pairing; although the other paired device will be able to until the user deletes the pairing on their device.

Alternatively, or additionally, configuration operations may be carried out by dragging named files within the relevant folder. In this case, an appropriate file (for example having the same base name but optionally with an additional prefix, suffix or filetype) is automatically generated for each pairing or other configuration entity. This can take advantage of the fact that file operations can often be simpler and less ambiguous than folder operations in various file systems (for example as regards copying or deleting folder or subfolder contents). It will be appreciated that all references herein to manipulating folders may also apply, where appropriate, to manipulating files. An appropriate file generation step, for example along the lines mentioned above, can be assumed.

Grouping enables data to be sent securely between a selected set of Encryption Devices. One-to-Many groups allow the group creator to encrypt a file that only a specified group of people (recipient members) can decode. This is a one-way communication. Many-to-Many groups allow file(s) to be encoded by selected members—known as ‘Originators’—and be decrypted by all members. This is a two-way communication for privileged members. Each Encryption Device may belong to multiple groups. The Encryption Device that created the group administers each individual group membership, and only the administration device needs to know who the members are. In order to create a group, the administration device must have been paired with all group members' devices. Pairing between other group members is not a pre-requisite.

The administrator should use the following process to establish and manage a group:

1. Pairings should be established with all proposed members' Encryption Devices.
2. A sub-folder should be created within the ‘Groups’ folder with the name of the group.
3. For each recipient member of the group, drag their sub-folder (from the ‘Paired’ folder) onto the named group folder.
4. Once all members have been added eject the Encryption Device.
5. When the device re-mounts all the original pairings (sub-folders) will be retained in the ‘Paired’ sub-folder, and the named group sub-folder will be populated.
6. The named group will contain a unique Inbox and Outbox to encrypt files for transfer to other group members.
7. An administrative sub-folder called ‘_Members’ is also created, containing empty sub-folders detailing recipient group members. The administration device is automatically added to the group. By default, all members will be able to decrypt files encrypted on the administration device (one-to-many grouping).
8. If the administrator wishes other (or all) members of the group to be able to encode files for the group (many-to-many grouping), this is readily achieved by dragging members' sub-folders (within _Members) to the ‘Originators’ sub-folder. The administration device will have been automatically added as an originator when the group was created. Originators may be removed (but remain as recipient group members).
9. Group members may be deleted within the ‘_Members’ folder by dragging the named folder(s) onto the ‘_DELETE’ folder. Once members are removed, the device should then be ejected and will remount having created revised membership credentials. These members will retain the ability to decrypt all historic group files, and be able to participate in future group activity using new encryption keys. Deleted members also retain the ability to read files encrypted prior to their removal.
10. Groups may be deleted by dragging the named group folder (within ‘Groups’) onto the ‘_DELETE’ folder. All members of the defunct group can continue decrypt historic data; however, there would be no admin for the group from this point on.
11. When the next file is sent to the group any deleted ‘Originators’ will be added to the blacklist for this group and further files from them may not be decoded. The deleted ‘Originator’ should be informed of their removal (or down grade if they are still a member) and should then delete their group folder by dragging it to the _DELETED folder. If a user is added back into the group the next message to the group will remove them from the blacklist.
12. When a recipient is removed from the group they will automatically be unable to decode future files encrypted for the group.

FIG. 19c is a screenshot of a process of adding members to a group (‘Audit_Team’).

FIG. 19d is a screenshot of a process of adding a user (George) to a group as an Originator member.

The following process should be used by group members to decode group files: a group member should decrypt group files simply by copying them to their Personal Inbox and following the process described previously in this document.

The following process should be used by Originator Members to encode group files: once a group member has been granted Originator status, a group file structure will be automatically created on the originator's Encryption Device when the next group file is decoded (as described above).

FIG. 19e is a screenshot of group sub-folders on an Originator device.

1. Group files may be encrypted via the group Inbox and Outbox.
2. Group files may be decrypted via the group or personal Inbox.

Note that Originator group members cannot see whom the other members are, nor choose a subset of members to transfer data between. This could be useful, for example, when data is shared anonymously in an online file sharing system such as Dropbox®.

Any Encryption Device may be an administrator (creator) of some groups and a Recipient/Originator member of others. Group management can be simplified with the aid of a helper application (see below).

For many users, loss or failure of the Encryption Device could lead to an undesirable situation where files cannot be decrypted. To address this, backup and recovery procedures enable an Encryption Device to be restored or cloned. These procedures are optional, because for other users it might be imperative that no recovery path exists.

Regarding backup, each Encryption device contains a root level folder named ‘Configuration’. Within this folder an encrypted file is maintained called ‘Backup.sd’.

This encrypted backup file contains all current pairing and group details and is encrypted with the devices unique security credentials and can thus only ever be restored to this device.

The backup file should regularly be copied from the device and backed up elsewhere. In general it should not be kept in the same location as the Recovery Module.

To restore a backup in the event of an issue:

1. Drag the backup file on to the root folder of the Encryption Device.
2. Eject the device.
3. The device will re-mount with the backup restored; overwriting the previous configuration (if any)

If only a few details (say a single pairing) is wanted from a backup the backup file should be dropped into a folder called ‘_PARTIAL.RES’ in the configuration folder. After the eject process this will be replaced by the folder hierarchy from the backup. Items can then be dragged from there back into place. On the next eject this restored folder will disappear. Backup management can be simplified with the aid of a helper application (see below).

The backup and restore process can return the user to a given point in time. If, however, the original device is lost or damaged the backup cannot be restored as it is unique to the device it was created for. To address this problem the ‘Recovery Device’ is used. Each Encryption Device creates unique security credentials (ID) the first time it is plugged in. These are stored in secure memory that cannot be accessed by the PC. Each device is supplied complete with a Recovery Module (as described above). This module is unique to the device it was supplied with and can be configured to hold the security credentials from the device it is supplied with. It must then be stored in a separate, secured location (or discarded, before use, if recovery is never desired).

If an Encryption device is lost or damaged then the first stage in recovery is to create a clone: that is, a device having the same set of credentials and volume name. This is a simple process:

1. Take another Encryption Device (it does not have to be new) and connect the original Recovery Module to it.
2. Plug it in to a computer (or any USB power source).
3. The Encryption Device will now sense that an alternative Recovery Module is attached and commence to clone itself from it. The LED will be lit when the process is complete.
4. Remove the Recovery Module from the device and connect the device to a computer. It should appear as a blank clone of the original device with the correct volume name. If the volume name does not match then this is an indication that a clone has been made from the wrong Recovery Module, and the process needs to be repeated.
5. The replacement Recovery Module may now be discarded (or possibly kept if it pertains to an older device that may need to be recovered at some point).
6. Records should be updated to associate the serial number of the original Recovery Module with the cloned Encryption Device and this module securely stored once more. Alternatively they may wish to use the new recovery device to backup this newly restored key—thus keeping serial numbers in sync.

The cloning procedure will not recover any of the pairings and groups—this is done by restoring a backup as described above. The recovery device is only writable by the encryption device it was shipped with. It can then be applied to any device new or old to create the clone. This is important as it ensures that the user can know that if they have the recovery device then no one else has the ability to create clones.

As described so far, if a device is lost or stolen then it is of course possible for the finder to decrypt data previously encrypted or to impersonate the owner when encrypting new files. To prevent this, it is possible to passphrase protect a device. A text file containing a pass-phrase is written to the root level on the device but will disappear following a re-mount.

To set a pass-phrase, open a text editor, and create a file of two lines. The first line is the chosen passphrase. The second line is an exact copy of the passphrase. Save the file in the top-level folder on the device with the name ‘password.txt’. Eject the device. If the above step is never carried out, the passphrase lock option is not enabled.

To change the passphrase, open a text editor, and create a file of three lines. The first line is the current passphrase. The second line contains the new passphrase and the third an exact copy of the new passphrase. Save the file in the top-level folder on the device with the name ‘password.txt’. Eject the device.

To remove the passphrase, open a text editor, and create the ‘password.txt’ file with line containing just the current passphrase. Eject the device.

Once set, every time you physically re-connect the device it will appear completely empty. The user then creates the appropriate one line passphrase file and ejects. The device will then remount as usual and will be available to use until it is unplugged. If the user gets into difficulty with pass-phrases then use the Recovery Module to restore. The helper application can help make this process more user friendly.

Whilst physical pairing provides ultimate security, there may be circumstances where this is not practical. In these cases, a secure method of remotely pairing Encryption Devices is required. A secure web service can be provided enabling users to establish a temporary remote pairing between devices based upon some shared secret that has been communicated via a separate channel (say, a telephone call). Following this initial pairing, the users can then securely send each other replacement keys (generated by their devices as if physically connected) to pair permanently. By this method, the web service provider would have no knowledge of the actual keys used between remotely paired devices, or any means to decrypt data by a backdoor. Whilst the web service concept could be extended to directly manage multiple remote devices this opens up the possibility of new attack vectors on security, so careful scrutiny is required.

Whilst the Encryption Device carries out all operations internally, it is advantageous to provide a ‘System Tray’ utility (small pop-up application) to act as a helper in managing the device. This aids pairing and group management, whilst automatically handling configuration backups and device ejection. All secure operations are still carried out on the Encryption Device itself: the helper application merely simplifies some of the operational steps described above.

There may be some options, which the user wishes to set. For example, a device could be configured such that it cannot decrypt files it has encrypted: leaving a file which can only be decrypted by the other device in the pairing. These options would be set in a user accessible setting file in the ‘Configuration’ folder.

The folder structures on the device are ‘virtual’ folders. They are created each time the device is mounted from data stored in an encrypted form inside the device. They are not actual folders stored on the device. The device stores no user data in an unencrypted form. It is possible for a user to rename folders in the ‘Paired’ folder to make them easier to manage. The device will keep track of this ‘friendly’ name and is aware whom the folder is actually paired with.

There may be consequences of users re-applying group files. Preferably some form of serial number is kept and users are prevented from going backwards (that is, sending a message to someone deleted from the device).

A button may be provided on the device to trigger encryption decryption but this may in some cases only work if the helper application is installed. An HID eject key-press may do the job, however, but in some cases may not actually eject the right device if more than one is inserted.

A more expensive version of the device includes a fingerprint sensor or pin keypad to protect the device, making the password solution less important.

In the preferred embodiment an empty password.txt file is always present so that, in general, a user simply double clicks it to edit in whatever the system editor may be. Consideration needs to be given to issues with internationalisation, Unicode and the like.

A key update procedure can be provided in any appropriate form (including those mentioned above).

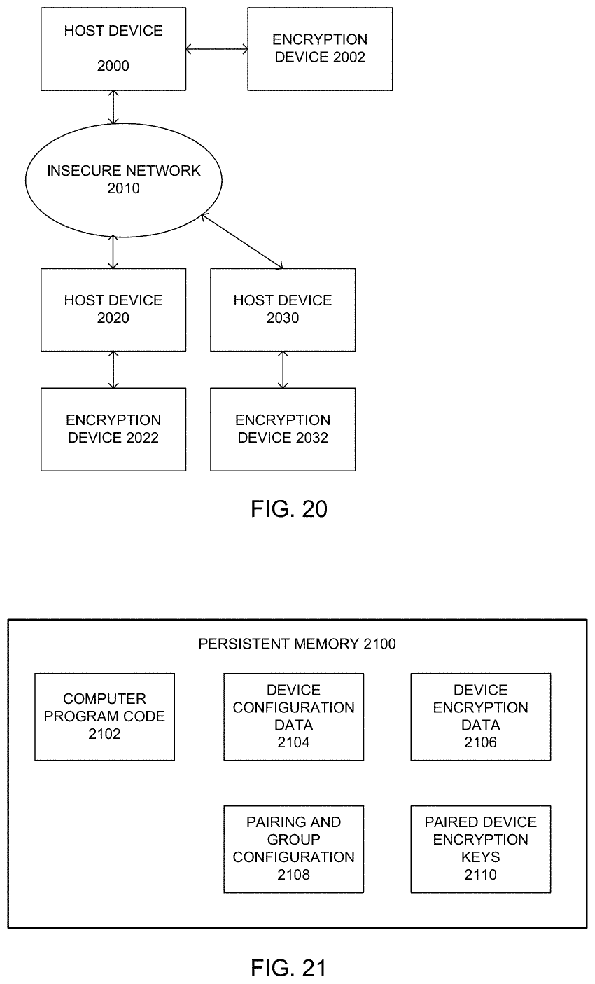

FIG. 20 is a schematic of a network of interconnected host devices and associated encryption devices, illustrating one of several possible structures of paired devices. Host device 2000 and the associated encryption device 2002 are for example originators of a group message. The message is transmitted via an insecure network 2010 (such as the Internet) to host devices 2020, 2030 and their associated encryption devices 2022, 2032.

The devices 2022, 2032 have been physically paired or temporarily paired over the network 2010, and are able to decrypt messages which were encrypted using the main encryption key of the encryption device 2002.

FIG. 21 is a schematic of the persistent memory module of a variant of the encryption device of FIG. 1, in which the file storage is held in non-persistent (volatile or automatically wipeable) memory. The persistent memory 2100 includes, as before (with reference to FIG. 3), computer program code 2102, device configuration data 2104, device encryption data 2106, pairing and group configuration data 2108 and paired device encryption keys 2110, but no general file storage facility.

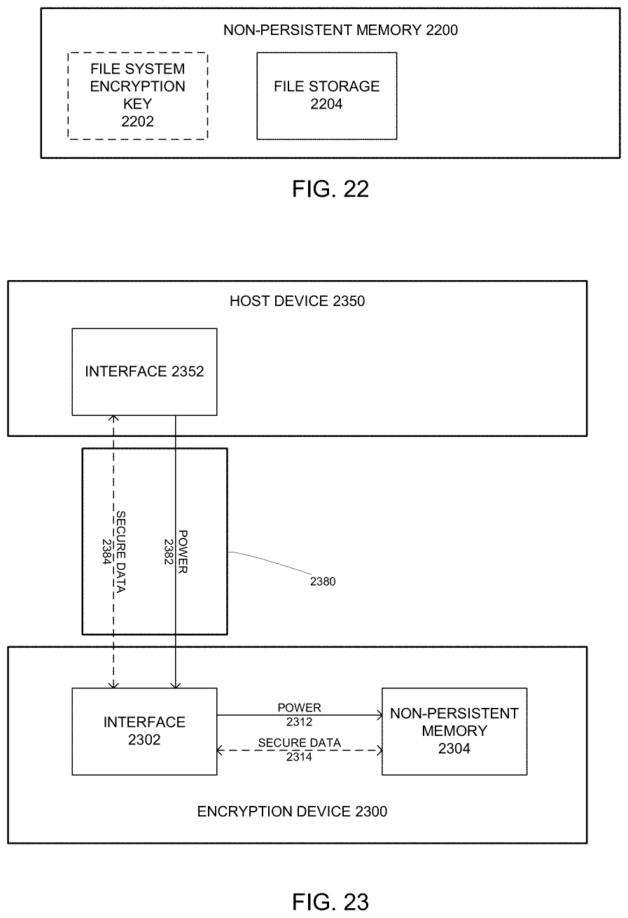

FIG. 22 is a schematic of the non-persistent memory module 2200 of the same variant of the encryption device of FIG. 1. The non-persistent memory includes the file system encryption key 2202, as before (with reference to FIG. 4), and also the file storage module/area 2204. In a further variant, which is less secure but simpler to implement, the file system encryption key 2202 is not present in the non-persistent memory, either because it is not used (because there is less need, since no persistent copy of the files exists) or because it is stored persistently or hard-coded into the computer program code (for the same reason). Using non-persistent memory may impose stricter constraints on file sizes and so on, which may require greater assistance on the host device (via a helper application, or similar) or otherwise reduce the usability of the system.

FIG. 23 is a schematic of the same variant of the encryption system of FIG. 1, illustrating signal and power connections. The encryption device 2300 (or general purpose or other specific purpose processing device) includes the interface 2302 and non-persistent memory 2304 as before (with reference to FIG. 7), which in this case also contains the file storage as described above. The host device 2350 includes an interface 2352, and is connected to the encryption device 2300 via a wired link 2380 as before. The link 2380 includes a power connection 2382, supplying power to the attached device 2300, and a (relatively safe from snooping) data connection 2384. Internally, the encryption device 2300 forwards on data and power to the non-persistent memory 2304 via internal power 2312 and data 2314 conduits, which (as described above) may pass through one or more intermediate devices and modules (such as the encrypt/decrypt module). As before, the non-persistent memory 2304 loses all data (including all stored files) as soon as it loses power. Thus it can be appreciated that the same automatic wiping mechanism described in relation to FIG. 7 applies in the present variant.

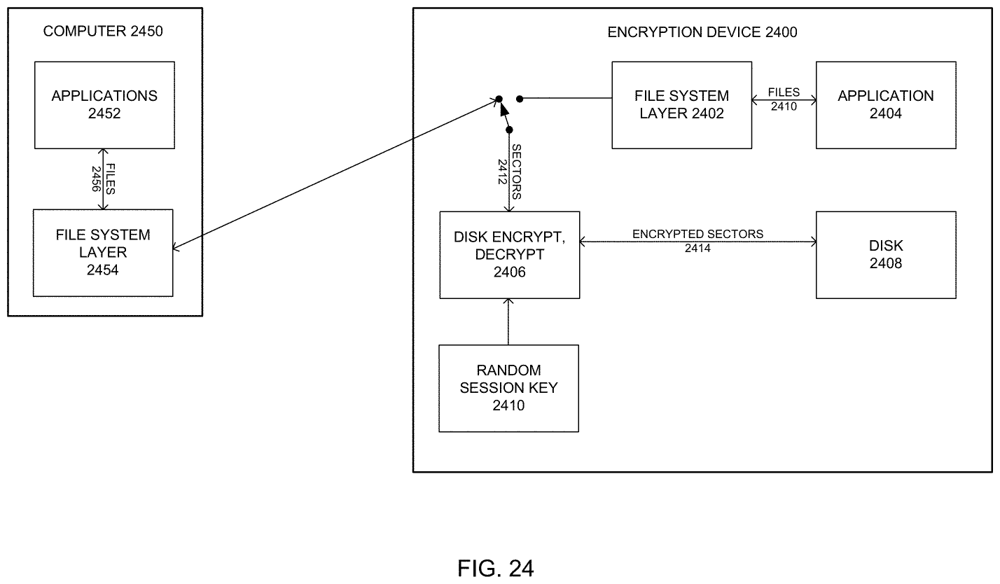

FIG. 24 is an alternative illustration of the filing system used by the device of FIGS. 1 and 9, showing the operation of the sector-based/filing system level encryption in more detail. The encryption device 2400 includes (conceptually) a filing system layer 2402, application(s) 2404, a disk encrypt/decrypt module 2406, a disk (physical storage device of any appropriate type) 2408 and a random session key store/generator 2410. An attached computer (host device) includes applications 2452 and a file system layer 2454. Files 2456 are passed between the applications 2452 and filing system layer 2454 on the computer 2450, and also between the computer 2450 and the encryption device 2400. Within the device 2400, files 2410 are passed to and from the application(s) controlling the device 2400 via the file system layer 2402. Behind the layer 2402, transparent to the application(s), which include the file encryption/decryption processes via sectors 2412, the file storage is managed, encrypting sectors 2414 as they pass to and from the disk 2408 on which they are stored, using the random session key 2410 (regenerated with each session).

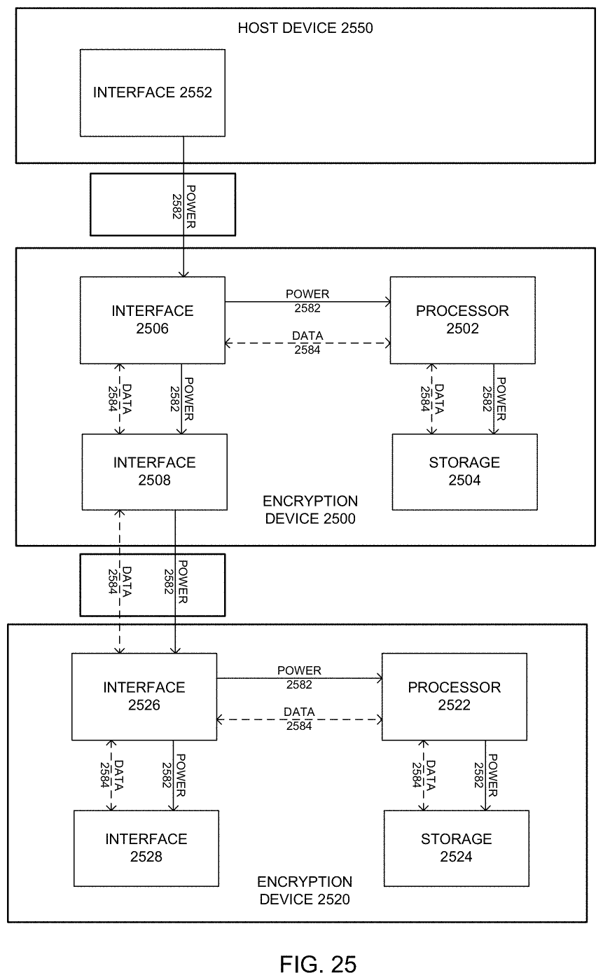

FIG. 25 is a schematic showing the pairing of two encryption devices. The aforesaid encryption device 2500 includes, amongst other things, a processor 2502, storage 2504 (including non-persistent file storage), a first interface 2506 and a further interface 2508. The first interface is a male USB interface and the further interface is a female USB interface, but other permutations are possible as explained above. A further/second encryption device 2520 is also shown, including the same features of a processor 2522, storage 2524, first interface 2526 and second interface 2528. The host device 2550 is also shown, including its own interface 2552 for connection to the first encryption device. The connections between the host device and the first and further encryption devices create links. In the case of pairing, a data connection with the host device 2550 is not necessarily (or ordinarily) required at the time of pairing. However, the host device 2550 serves the purpose of providing power 2582, which is distributed internally within the first encryption device 2500 and then forwarded on to the further device 2520. The data connection 2584 is, however, used between the two encryption devices 2500, 2520. Other permutations of connection, protocols, and so on are possible as described above.

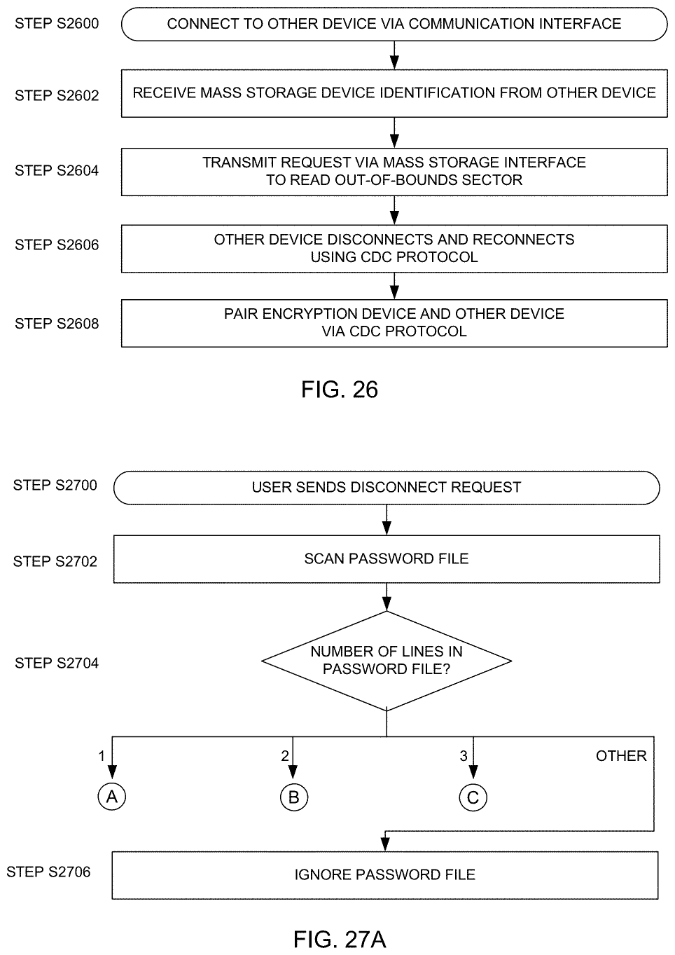

FIG. 26 shows the step of connecting to the proposed paired device (the ‘other device’) via a communication interface (such as a female second USB interface on the opposite side of the device to the male USB interface used to connect to host devices). In step S2602, mass storage device identification is received from the other device, indicating that the other device is attempting to connect via the USB interface as a mass storage device. This is because the other device (being of the same type) by default assumes that it is connected to a host device such as a PC. The mass storage device is relatively unwieldy for two-way communication, however, and there is no generally known or in-built mechanism to communicate general (rather than mass storage-specific) information via the mass storage protocol. The previously described mechanism of transmitting disconnection requests is of course possible, but this requires a disconnection and reconnection to take place each time the communication changes direction and is thus relatively unwieldy (though offers advantages over any previously known system). Instead, in step S2604, the encryption device sends a read request for a sector which is known to be outside the reported size of the other device's virtual file system. This is an unintuitive thing to do, since it is an incorrect command and can be expected to cause an error. However, the out of bounds read request and, if necessary, its characteristics such as how far outside of bounds it is and at what point in the communication it is sent (that is, at the beginning), can be used to signal to the other device that a different protocol is requested. It will be appreciated that this principle can be applied more broadly to other sorts of devices to allow one device to signal to the other via a mass storage interface that a different protocol is required, or to carry out any other kind of signalling as appropriate. In step S2606, the other device, having received information confirming that it is connected to a like device, disconnects in response to the out of bounds request, and reconnects using the CDC protocol (or any other appropriate protocol as discussed above). The encryption device and other device can then pair (S2608) relatively efficiently via the CDC connection and carry out encryption key sharing, permission management and/or any other operation. Typically, once the operation is complete, either or both devices signals this to the user via an appropriate means such as a flashing LED or an audible beep (or both).

Other approaches are possible, such as writing a ‘magic’ file into the filing system presented by the other device and then ejecting. This is less desirable, however, in the case that a real mass storage device is plugged into the device (which will not recognise, nor delete, the ‘magic’ file).

Normally a user will choose to change the device password by first carrying out an authentication (as is described below in more detail) and then making a modification to a configuration file, which may have a standard name (such as ‘config.txt’) and a standard location (for example in the root directory, or in a ‘config’ subfolder). The configuration file may have a line such as ‘password=xxx’ or similar.

Other methods of processing passwords (both to change it and to provide it for authentication) are possible. In particular, a text file can be used (advantageously either before or after authentication of the device) to manage passwords, as described below. Some alternative methods of providing user authentication will then be described.

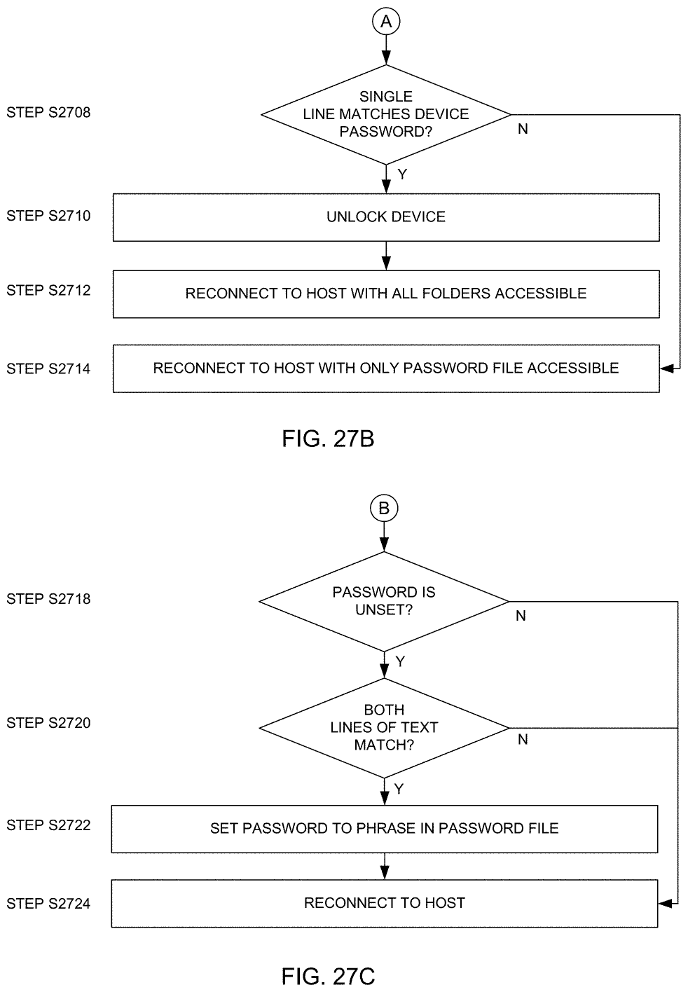

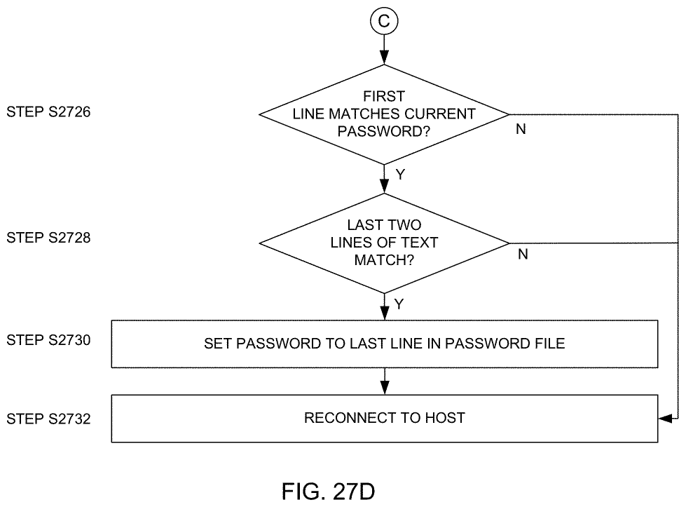

FIGS. 27A to 27D are flowcharts illustrating the process of processing a password file modified by a user. After the user sends a disconnection request (Step S2700) after interacting with the device, the (initially empty) password file is scanned (S2702). The password file is typically called ‘password.txt’ and is stored in the root of the mass storage device, but could be called anything and stored anywhere appropriate.

In the case (A) where the password file contains one line, the device tests (S2708) whether the single line matches a stored password. If so, the device is unlocked (S2710) and the device reconnects to the host with all the normal files and folders accessible (S2712). If the single line in the password file does not match the current password, the device reconnects to the host with only the password file still accessible and blanked out again (S2714).

In the case (B) where the password file contains two lines, the device tests (S2718) whether the password is unset. If so, the device tests (S2720) whether the two lines of text match. Again if so, the device sets (S2722) the device password to be the phrase repeated across the two lines of text. The device then reconnects (S2724) to the host.

In the case (C) where the password file contains three lines, the device tests (S2726) whether the first line of the file matches the current password, and if so further tests (S2728) if the last two lines of the file (duplicate copies of the new password) match each other. If so, the password is set (S2730) to the last line (or penultimate line, being the same). In all cases, the device then reconnects (S2732) to the host. In some cases it may be desired only to allow changing of the password after a successful unlocking of the device by any appropriate means. It may also be desired to disregard the first line and the test relating thereto in the event that no password has yet been set.

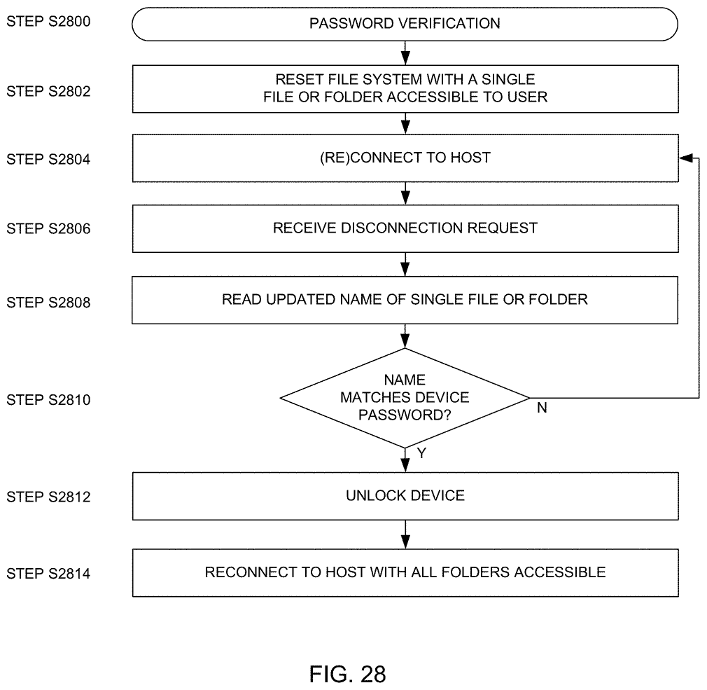

FIG. 28 is a flowchart illustrating an alternative method of unlocking a device with a password. In the case where the system is locked and a password has been set by any appropriate means (including those described above), the password verification process (S2800) begins with the file system as presented to the user resetting to a single file or folder accessible/visible to the user (S2802). For example, a single folder may be created called ‘rename-to-password’ or similar. In step S2804, the device reconnects to the host and mounts the file system (with the single folder) via the mass storage interface as usual.

The user can now rename the folder to the current password, though the device cannot track this activity at the time. After the user sends a disconnection request (S2806), for example by ejecting the virtual mass storage device in the usual way, the device reads the updated name of the single file or folder (if indeed it has been updated) in step S2808 and tests (S2810 whether the new name of the file/folder matches the current password. If so, the device is unlocked (S2812) and the device reconnects to the host with all folders accessible in the normal course of use (S2814). If the password does not match, the process repeats (S2802) and the default file/folder is again presented to the user. The advantage of this process is that the user only has to rename a file or folder using the normal file system interface and is not required to possess, run or use a text editor or similar.

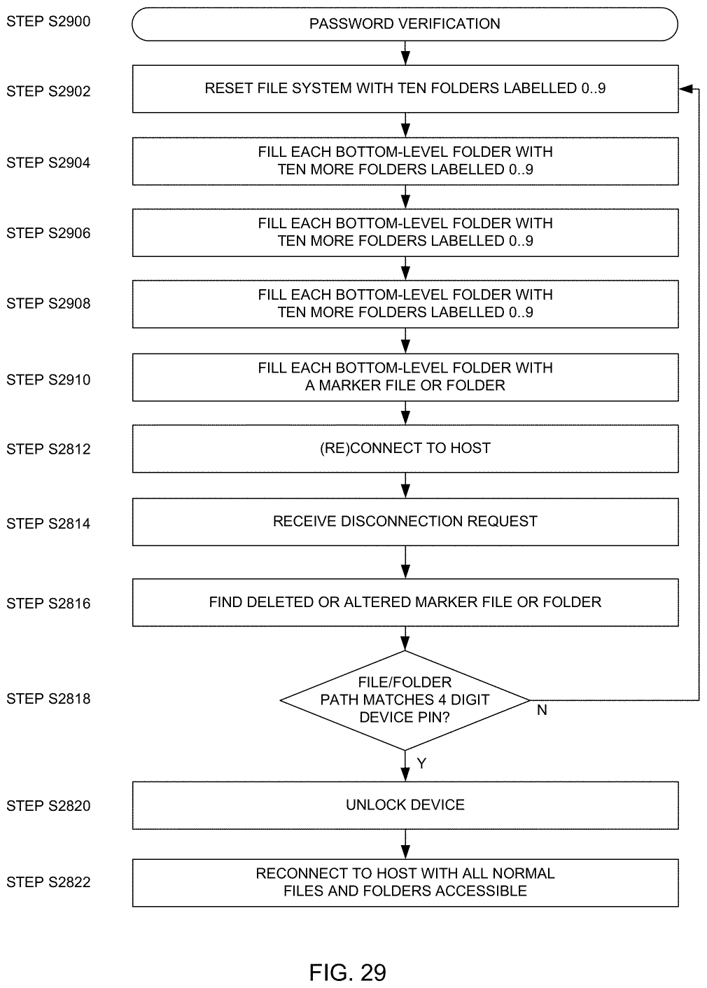

FIG. 29 is a flowchart illustrating a method of unlocking a device with a numeric PIN. This provides an alternative method which does not even require the entry of any text via a keyboard, or similar. The password verification (S2900) begins with the file system being reset (S2902) with ten folders labelled 0, 1, 2, 3, 4, 5, 6, 7, 8, 9 and 0. Each folder corresponds to the first digit of a four digit PIN. Each of these folders is filled with ten more folders labelled 0 to 9 (S2904). This process repeats (S2906, S2908) until a folder tree is formed to a constant depth of four folders, allowing a unique selection of any PIN in the range of 0000 to 9999 via appropriate navigation of the folder tree. Each bottom-level folder is then filled (S2910) with a marker file or folder, for example called ‘enter-pin’ or similar.

The device then connects or reconnects to the host (S2812) as usual, and the user can then take appropriate action. After a disconnection request is received by the device (S2814), the device scans the folders to find a deleted or altered marker file or folder. Normally the PIN is indicated by deleting the relevant marker file, although alternative methods (such as carrying out any action that alters the contents of the file or folder, or alters the meta data such as the time stamp) can be used. For example, the user may have selected the folder ‘1’, then sub-folder ‘3’, then sub-folder ‘8’, then sub-folder ‘2’ and deleted the file ‘enter-pin.txt’ within that last sub-folder. In step S2814, the device would then infer from the absence of that specific ‘enter-pin-txt’ file that PIN 1382 had been selected/entered.

The device tests (S2818) whether the entered PIN corresponds to the 4 digit PIN used to lock the device (and set by any appropriate method such as the password file, or the 0-9 subfolder method described above). If so, the device is unlocked (S2820), and reconnects to the host with all normal files and folders accessible (S2822). If the PIN does not match, the process repeats from step S2902.

This method can be extended as appropriate to any number of digits (for example a 6-digit PIN or a 3-digit PIN) and can be combined with a password or other authentication method using any appropriate method as described above or otherwise. The method is not limited to numbers, and could be used as a more general method to enter text or mixed character passwords, and so on.

It will be appreciated that the methods described above in relation to FIGS. 27A to 29 are applicable to essentially any device, application or computer sub-system in which it may be convenient or desirable to allow authentication by direct manipulation of a file system structure or contents. Accordingly, features described above in relation to password files or the methods set out in FIGS. 27A to 29 specifically may be provided in independent form as/where appropriate.

It will be appreciated that any references herein to (virtual) folders and manipulation thereof (such as deletion, renaming, and so on, so as to convey information to the encryption/processing device) may, as appropriate, equally or additionally be applied to (virtual) files. For example, the encryption device may configured to receive a command to modify a virtual file, and wherein the encryption or processing device is caused to carry out at least one configuration operation in dependence on said modification.

In the foregoing embodiments, the encryption keys are symmetric, and the encryption methods may include (but are not limited to) DES, triple-DES, AES, and other symmetric encryption methods. Any appropriately long key length can be used to ensure ongoing cryptographic security. Methods such as PGP and other public/private key systems can be used for authentication or encryption purposes, either within the encryption devices, between the devices and attached host devices (for example in communication with a helper app on the host device), or between the encryption devices and remote devices, such as other encryption devices. Public/private key schemes can also be used in place of the symmetric key encryption schemes if appropriate or desired, though this would not be expected to result directly in better performance or security (since the key is never shared unencrypted over unsecured links).

It will be appreciated that further modifications may be made to the invention, where appropriate, within the spirit and scope of the claims.

1. An encryption device comprising:
an interface for connecting to a host device;
at least one processor; and
computer program code executable by said at least one processor,
wherein the computer program code, when executed by said at least one processor, causes the encryption device:
to receive at least one file for processing from the host device via the interface;
to receive a disconnection request; and
in response to the disconnection request:
to perform an encryption or decryption operation on said at least one file.

2. An encryption device according to claim 1, wherein the interface is a mass storage interface, and said at least one file is received using a mass storage protocol associated with the mass storage interface.

3. An encryption device according to claim 1 or 2, further comprising:
a file storage module, and
wherein the device is further caused, on receiving said at least one file, to store said at least one file in the file storage module, and
wherein performing the encryption or decryption operation comprises replacing each file in the file storage module with a processed version.

4. An encryption device according to claim 3, wherein the encryption device is further caused:
to add filing system level encryption to each file as it is stored in the file storage module using a filing system encryption key;
to remove the filing system level encryption from each file as it is read out of the file storage module using the filing system encryption key.

5. An encryption device according to claim 4, wherein each file is received as one or more separate portions, and the filing system level encryption is applied to each portion as it is stored.

6. An encryption device according to claim 5, wherein the encryption device is configured such that the filing system encryption key is stored in non-persistent memory and is deleted in response to the encryption device being removed from the host.

7. An encryption device according to any one of claims 3 to 6, wherein the encryption device is configured such that the files in the file storage module are stored in non-persistent memory and are deleted in response to the encryption device being removed from the host.

8. An encryption device according to claim 6 or 7, wherein the non-persistent data storage is powered by the host device via the mass storage interface, and wherein removing power from the non-persistent data storage causes the contents of the data storage to be erased, whereby removing the encryption device from the host device automatically prevents decryption of files stored in the file storage module.

9. An encryption device according to any one of claims 3 to 8, wherein the encryption device is further caused:
to present at least one virtual folder to the host device via the mass storage interface;
to receive an association between each file and a respective virtual folder; and
to perform a processing task on each file in dependence on its respective virtual folder.

10. An encryption device according to any one of claims 3 to 9, wherein the encryption device is configured to receive at least one further file via the mass storage interface, and wherein the encryption device is further caused to identify said at least one further file as a configuration file, and wherein the encryption device is further caused to carry out at least one configuration operation in dependence on the said at least one further file.

11. An encryption device according to claim 9, wherein the encryption device is configured to receive a command to modify a virtual file or folder, and wherein the encryption device is further caused to carry out at least one configuration operation in dependence on said modification.

12. An encryption device according to claim 10 or 11, wherein the configuration operation comprises at least one of: storing configuration data, modifying configuration data, modifying access rights, creating access rights, creating authentication data and modifying authentication data.

13. An encryption device according to any preceding claim, wherein the device is further caused to reconnect to the host after performing the encryption or decryption operation.

14. An encryption device according to any preceding claim, wherein the encryption device is further caused to disconnect electronically from the host device while remaining in physical contact.

15. An encryption device according to any preceding claim, wherein the interface is a USB interface and reconnecting to the USB host comprises sending a USB connection request to the host device.

16. An encryption device according to any preceding claim, wherein the encryption device is further caused to receive a disconnection request, and preferably the interface is a USB interface and the disconnection request is a USB eject request.

17. An encryption device according to any preceding claim, wherein the device is further caused to receive authentication data, and wherein the encryption device is further caused to validate the authentication data before performing an encryption or decryption operation on said at least one file.

18. An encryption device according to claim 17, wherein the authentication data is at least one of: a password; pass key; PIN; public key; cryptographic signature; text or other data within at least one file or folder; a name given to a file or folder during a renaming operation; and the deletion, addition or alteration of a file or folder in a location within a file system that is indicative of a pass phrase or code.

19. An encryption device according to claim 18, wherein the authentication data is communicated by the deletion, addition or alteration of a file or folder, said file or folder being located within at least one subfolder, each subfolder corresponding to a portion of the pass phrase or code, and the pass phrase or code being formed by combining the portions of the pass phrase or code relating to each respective subfolder.

20. An encryption device according to any preceding claim, whereby the encryption device is attachable to a further said encryption device, and wherein the encryption device is further caused to communicate with the further encryption device to facilitate the exchange of cryptographic data.

21. An encryption device according to claim 20, further comprising a further interface of the same type as the first interface, for attachment to the further said encryption device, wherein the encryption device is attachable to the second encryption device via either the first interface or the second interface.

22. An encryption device according to claim 20 or 21, wherein the encryption device is further caused to pair with the further encryption device.

23. An encryption device according to claim 22, wherein the encryption device is further caused to exchange cryptographic keys with the further encryption device, such that at least one said encryption device is able to decrypt files encrypted by the other said encryption device.

24. An encryption device according to claim 22 or 23 when dependent on claim 9, wherein the said at least one virtual folder includes at least one virtual folder representing the pairing between the encryption devices.

25. An encryption device according to any one of claims 22 to 24, further caused to receive a pairing request from a remote encryption device to which it is not physically connected, and to pair with the remote encryption device by exchanging messages with the remote encryption device.

26. An encryption device according to claim 25, further caused to create a new pairing with the remote device on detection of the remote device being attached to the encryption device via a second interface.

27. An encryption device according to any one of claims 22 to 26, wherein the encryption device is caused to be paired in a one-to-many fashion with a plurality of other devices, whereby the encryption device is designated as an originator device and the plurality of other devices are designated as group devices.

28. An encryption device according to any one of claims 22 to 26, wherein the encryption device is caused to be paired in a many-to-many fashion with a plurality of other devices, whereby all of the devices are designated as group devices.

29. An encryption device according to claim 28, wherein a predetermined set of devices selected from the group devices are designated as originators, and are capable of encrypting files that can be decrypted by all of the group devices.

30. An encryption device according to any preceding claim, wherein the encryption device is further caused to:
detect connection of a reprogramming module;
to receive configuration data from the reprogramming module, and
to store the configuration data,
wherein preferably the configuration data includes cryptographic data that is used to perform the encryption or decryption operation.

31. An encryption device according to any preceding claim, wherein the encryption device is further caused to generate a backup data file for export, said backup data file including configuration data from the encryption device, and to encrypt the backup data file.

32. A processing device, comprising:
a mass storage interface for connecting to a host device;
at least one processor; and
computer program code executable by said at least one processor,
wherein the computer program code, when executed by said at least one processor, causes the processing device:
to receive at least one file from the host device via the mass storage interface;
to receive a disconnection request via the mass storage interface; and
in response to the disconnection request, to perform a processing task on each file.

33. A processing device according to claim 32, wherein the processing device is further caused:
to present at least one virtual folder to the host device via the mass storage interface;
to receive an association between each file and a respective virtual folder; and
to perform a processing task on each file in dependence on its respective folder.

34. A processing device having a mass storage interface connectable to a host device, the mass storage interface being usable in connection with a mass storage protocol, and the processing device being configured to receive at least one file from the host device using the mass storage protocol, and to transmit said at least one file back to the host device using the mass storage protocol, wherein said at least one file is returned to the host device in a transformed state.

35. A processing device according to claim 34, wherein the processing device processes said at least one file, preferably to enhance it, more preferably to encrypt or decrypt the files, and wherein the mass storage protocol is preferably the USB mass storage protocol.

36. A method of carrying out a session-based task in a device presenting a mass storage interface, the method comprising:
connecting to a host device via the mass storage interface;
receiving a disconnection request from the host device via the mass storage interface; and in response to the disconnection request:
disconnecting from the host device; and
carrying out the session-based task.
